(19) United States
(12) Patent Application Publication
(10) Pub. No.: US 2023/0180173 A1
(43) Pub. Date: Jun. 8, 2023

(54) USER EQUIPMENT POSITIONING MEASUREMENT PROCEDURES UNDER ACTIVE BANDWIDTH PART SWITCHING, CORRESPONDING DEVICES AND NON-TRANSITORY COMPUTER-READABLE STORAGE MEDIUM

(71) Applicant: Telefonaktiebolaget LM Ericsson (PUBL), Stockholm (SE)

(72) Inventors: Muhammad Ali KAZMI, Sundbyberg (SE); Iana SIOMINA, Täby (SE); Christopher CALLENDER, Kinross (GB)

(21) Appl. No.: 17/995,489

(22) PCT Filed: Apr. 9, 2021
(86) PCT No.: PCT/EP2021/059311

§ 371 Date: Oct. 5, 2022

Related U.S. Application Data
(60) Provisional application No. 63/007,404, filed on Apr. 9, 2020.

(51) Int. Cl. H04W 64/00; H04W 24/10; H04W 48/18

(52) U.S. Cl. CPC H04W 64/00; H04W 24/10; H04W 48/18

(57) ABSTRACT

A method (1200) by a wireless device (110) includes determining (1202) that switching from a first active bandwidth part, BWP, to a second BWP in a first cell will affect at least one positioning measurement occasion, PMO, during which at least one positioning measurement is to be performed. The wireless device suspends (1204) the at least one positioning measurement while performing the active BWP switching from the first active BWP to the second active BWP in the first cell.

### TECHNICAL FIELD

The present disclosure relates, in general, to wireless communications and, more particularly, systems and methods relating to user equipment positioning measurement procedures under active bandwidth part switching.

### BACKGROUND

New Radio (NR), which may also be known as 55^{th} Generation (5G) or Next Generation, architecture is being discussed in 3^{rd} Generation Partnership Project (3GPP). FIG. 1 illustrates the current concept. As depicted, gNodeB (gNB) and Next Generation-eNodeB (ng-eNB or evolved eNB) denote New Radio base stations (NR BSs) (one NR BS may correspond to one or more transmission/reception points (TRPs)), and the lines between the nodes illustrate the corresponding interfaces. It is generally recognized that the gNB and the ng-eNB may not always both be present. Additionally, when both the gNB and the ng-eNB are present, the NG-C interface is only present for one of them.

Location Management Function (LMF) is the location node in New Radio (NR). There are also interactions between the location node and the gNB via the NR Positioning Protocol A (NRPPa) (not illustrated in FIG. 1) and between a User Equipment (UE) and the location server via NR LTE Positioning Protocol (NR LPP). The interactions between the gNB and the UE is supported via the Radio Resource Control (RRC) protocol.

The following NR positioning measurements performed by the UE have been specified:
Reference Signal Time Difference (RSTD): This is the reference signal time difference between the positioning node j and the reference positioning node i.
Positioning Reference Signal-Reference Signal Received Power (PRS-RSRP): The linear average over the power contributions (in [W]) of the resource elements that carry Downlink Positioning Reference Signals (DL PRSs).
UE Receive-Transmit (Rx-Tx) time difference: It is defined as T_{UE-RX}-T_{UE-TX} where:
   T_{UE-RX} is the UE received timing of downlink subframe #i from a positioning node, defined by the first detected path in time. It is measured on Positioning Reference Signal (PRS) signals received from the gNB.
   T_{UE-TX} is the UE transmit timing of uplink subframe #j that is closest in time to the subframe #i received from the positioning node. It is measured on Sounding Reference Signal (SRS) signals transmitted by the UE.

Synchronization Signal Block (SSB) and Channel State Information-Reference Signal (CSI-RS) based measurements defined for mobility include, for example, Synchronization Signal-Reference Signal Received Power (SS-RSRP), Synchronization Signal-Reference Signal Received Quality (SS-RSRQ), Channel State Information-Reference Signal Received Power (CSI-RSRP), Channel State Information-Reference Signal Received Quality (CSI-RSRQ), etc.

### Reference Signals for NR Positioning Measurements

Positioning Reference Signals

Positioning reference signals (PRS) are periodically transmitted on a positioning frequency layer in PRS resources in the downlink (DL) by the gNB. The information about the PRS resources is signaled to the UE by the positioning node via higher layers but may also be provided by base station such as by broadcast. Each positioning frequency layer comprises PRS resource sets, where each PRS resource set comprises one or more PRS resources. All the DL PRS resources within one PRS resource set are configured with the same periodicity. The PRS resource periodicity (Tₚₑᵣ^{PRS}) comprises:
Tₚₑᵣ^{PRS}∈2^{μ} {4, 8, 16, 32, 64, 5, 10, 20, 40, 80, 160, 320, 640, 1280, 2560, 5120, 10240, 20480} slots, where μ=0, 1, 2, 3 for PRS SCS of 15, 30, 60 and 120 kHz respectively. Tₚₑᵣ^{PRS}=2^{μ}·20480 is not supported for μ=0.

Each PRS resource can also be repeated within one PRS resource set and takes values Tᵣₑₚ^{PRS}∈{1,2,4,6,8,16,32}.

PRS are transmitted in consecutive number of symbols (L_{PRS}) within a slot: L_{PRS}∈{2,4,6,12}. The following DL PRS RE patterns, with comb size K_{PRS} equal to number of symbols L_{PRS} are supported
Comb-2: Symbols {0, 1} have relative RE offsets {0, 1}
Comb-4: Symbols {0, 1, 2, 3} have relative RE offsets {0, 2, 1, 3}
Comb-6: Symbols {0, 1, 2, 3, 4, 5} have relative RE offsets {0, 3, 1, 4, 2, 5}

Maximum PRS BW is 272 PRBs. Minimum PRS BW is 24 PRBs. The configured PRS BW is always a multiple of 4.

Sounding Reference Signals (SRS)

For positioning measurement, the UE can be configured (typically by the serving base station) with SRS resource for SRS transmission in Nₛ∈{1,2,4,8,12} number of adjacent symbols anywhere within the slot. The periodic SRS resource can be configured with a periodicity (T_{SRS}):
T_{SRS}∈{1, 2, 4, 5, 8, 10, 16, 20, 32, 40, 64, 80, 160, 320, 640, 1280, 2560} slots

SRS BW is also configurable and can vary from 4 PRBs to 272 PRBs.

Bandwidth Part Operation

To enable the UE power saving and avoid interference, the UE can be configured by the higher layer with a set of bandwidth parts (BWPs) for receptions by the UE (DL BWP set e.g. up to 4 DL BWPs)) and a set of BWPs for transmissions by the UE (UL BWP set (e.g. up to 4 UL BWPs) in a serving cell, e.g. SpCell (e.g. Primary Cell (PCell), Primary Secondary Cell (PSCell)), Secondary Cell (SCell) etc. Generally, SpCell either refers to the PCell of the MCG or the PSCell of the SCG depending on if the MAC entity is associated to the MCG or the SCG, respectively

Each BWP can be associated with multiple parameters. Examples of such parameters are: BW (e.g. number of time-frequency resources (e.g. resource blocks such as 25 PRBs etc.), location of BWP in frequency (e.g. starting Resource Block (RB) index of BWP or center frequency, etc.), subcarrier spacing (SCS), cyclic prefix, any other baseband parameter (e.g. Multiple Input-Multiple Output (MIMO) layer, receivers, transmitters, Hybrid Automatic Repeat Request (HARQ) related parameters etc.) etc.

The UE is served (e.g. receive and transmits signals) only on the active BWP(s). At least one of the configured DL BWPs can be active for reception and at least one of the configured UL BWPs can be active for transmission in the serving cell. The UE can be configured to switch the active BWP based on a timer (e.g. BWP inactivity timer such as bwp-InactivityTimer), by receiving a command or a message from another node (e.g. from the BS) etc. Examples of command or messages are downlink control information (DCI) sent on Physical Downlink Control Channel (PDCCH), RRC message, Medium Access Control (MAC), etc. Any active BWP can be switched independently. For example, UL and DL active BWPs can be switched separately. The active BWP switching operation may involve change in one or more parameters associated with the BWP (described above e.g. BW, frequency location, etc.).

For example, when the timer (e.g. bwp-InactivityTimer) expires the UE may be required to switch to a reference active BWP, e.g., a default active BWP, one of the configured BWPs, etc.

In another example, when the UE receives a DCI command to switch an active BWP, then the UE may be required to switch its current active BWP to one of the configured BWPs indicated in the command.

In yet another example, when the UE receives a RRC message to switch an active BWP, then the UE may be required to switch its current active BWP to a new BWP indicated in the RRC message; this may also be called as reconfiguration of the active BWP. The switching may also comprise whereby the UE is first time configured with an active BWP e.g. when enters in RRC connected state.

FIG. 2 illustrates an example of the active BWP switching. For example, as depicted, the UE is configured with 4 different BWPs: BWP1, BWP2, BWP3 and BWP4, which are associated with different set of parameters. The UE can be configured to switch its active BWP based on any of timer, DCI command or RRC message (which also includes long RRC procedure delay e.g. 10 ms). For example, the UE may be switched first from the current active BWP1 to a new BWP2, which becomes the new active BWP. The active BWP2 may then be further switched to BWP3, which in turn becomes the new active BWP. The active BWP-3 may then be further switched to BWP4, which in turn becomes the new active BWP. The active BWP switching involves delay such as, for example, X number of slots, which depend on type of BWP switching, numerology of BWP before and after the switching, etc.

Certain problems exist. For example, the UE performs positioning measurements such as, for example, RSTD, PRS-RSRP, UE Rx-Tx, etc., over a measurement period, which can span over several frames and can even be up to several seconds depending on reference signal (RS) configuration parameters (e.g. PRS and/or SRS configuration). Using a previously proposed method, a UE performs positioning measurements on cells of the serving carrier within the active BWP of the serving cell. This requires that the reference signal (RS) (e.g. PRS/SRS, etc.) used for positioning measurements are always within the active BWP over the entire measurement period. Apparently, one advantage of this solution is avoiding the use of measurement gaps for the positioning measurements; but one main problem with this approach is putting stringent constraint(s) on the network such as, for example, scheduling restrictions. The UE's serving base station manages the BWP operation of the UE. For example, the UE's serving base station configures the UE with parameters related to BWP switching (e.g. BWP inactivity timer) and/or switches the active BWP, etc. But, the UE is configured for doing positioning measurements (e.g. RSTD, etc.) by the positioning node (e.g. LMF, etc.) e.g. via LPP protocol. This means the UE's serving base station is not aware of when the and for how long the UE performs the positioning measurements. Therefore, another problem is that the serving base station constantly relies on the UE input for any operation related to the active BWP switching. This will impact scheduling of signals on, for example, the Physical Downlink Shared Channel (PDSCH) , Physical Uplink Shared Chanel (PUSCH), etc., which is done within the active BWP. For example, the scheduling constraints can degrade UE throughput, or cause increased UE power consumption through use of a larger BWP when no positioning measurement is being made.

### SUMMARY

Certain aspects of the present disclosure and their embodiments may provide solutions to these or other challenges. In an example scenario, a UE performing a positioning measurement may be triggered to perform an active BWP switching. During the active BWP switching delay time the UE may also cause interruption in the transmission/reception of a serving cell. According to certain embodiments, methods, systems, and techniques are provided for defining UE behavior if the active BWP switching impacts or is expected to impact one or more positioning measurement occasions.

According to certain embodiments, a method by a wireless device includes determining that switching from a first active BWP to a second BWP in a first cell will affect at least one PMO during which at least one positioning measurement is to be performed. The at least one positioning measurement is suspended while performing the active BWP switching from the first active BWP to the second active BWP in the first cell.

According to certain embodiments, a wireless device includes processing circuitry configured to determine that switching from a first active BWP to a second BWP in a first cell will affect at least one PMO during which at least one positioning measurement is to be performed. The processing circuitry is configured to suspend the at least one positioning measurement while performing the active BWP switching from the first active BWP to the second active BWP in the first cell.

According to certain embodiments, a method by a network node includes receiving a request for a measurement gap configuration for performing at least one positioning measurement by a wireless device while or in response to performing active BWP switching from a first active BWP to a second BWP in a first cell. The network node modifies a positioning measurement configuration to include a measurement gap configuration and transmits the modified positioning measurement configuration including the measurement gap configuration to the wireless device.

According to certain embodiments, a network node includes processing circuitry configured to receive a request for a measurement gap configuration for performing at least one positioning measurement by a wireless device while or in response to performing active BWP switching from a first active BWP to a second BWP in a first cell. The processing circuitry is configured to modify a positioning measurement configuration to include a measurement gap configuration and transmit the modified positioning measurement configuration including the measurement gap configuration to the wireless device.

Certain embodiments may provide one or more of the following technical advantages. For example, one technical advantage may be that certain embodiments define UE behavior if the active BWP switching is triggered while the UE is doing the positioning measurements. As another example, a technical advantage may be that certain embodiments ensure that the UE meets performance of positioning measurement if the active BWP switching is triggered while the UE is doing the positioning measurements.

As another example, a technical advantage may be that certain embodiments reduce or at least minimize the interruption of positioning RS (e.g. PRS, SRS, etc.) due to the active BWP switching.

As another example, a technical advantage may be that certain embodiments enable the network node (e.g. positioning node) to adapt positioning measurement configuration to ensure that the UE continues doing the positioning measurements even if the active BWP switching is triggered.

As another example, a technical advantage may be that certain embodiments enable the requirements for emergency call, which relies on critical positioning methods (e.g. OTDOA based on RSTD), to be met even if the active BWP switching occurs during the positioning measurement.

As another example, a technical advantage may be that certain embodiments allow network base station nodes to adjust active BWP to maintain UE throughput, or to save power at the UE without static limitations from the possibility that a positioning measurement is ongoing in the UE.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates the current architecture for New Radio (NR);

FIG. 2 illustrates an example of the active Bandwidth Part (BWP) switching;

FIG. 3 illustrates an example of active BWP switching while a user equipment (UE) is performing positioning measurements on reference signals (RS) operating within the positioning measurement occasions, according to certain embodiments;

FIG. 4 illustrates an example wireless network, according to certain embodiments;

FIG. 5 illustrates an example network node, according to certain embodiments;

FIG. 6 illustrates an example wireless device, according to certain embodiments;

FIG. 7 illustrate an example user equipment, according to certain embodiments;

FIG. 8 illustrates a virtualization environment in which functions implemented by some embodiments may be virtualized, according to certain embodiments;

FIG. 9 illustrates a telecommunication network connected via an intermediate network to a host computer, according to certain embodiments;

FIG. 10 illustrates a generalized block diagram of a host computer communicating via a base station with a user equipment over a partially wireless connection, according to certain embodiments;

FIG. 11 illustrates a method implemented in a communication system, according to one embodiment;

FIG. 12 illustrates another method implemented in a communication system, according to one embodiment;

FIG. 13 illustrates another method implemented in a communication system, according to one embodiment;

FIG. 14 illustrates another method implemented in a communication system, according to one embodiment;

FIG. 15 illustrates an example method by a wireless device, according to certain embodiments;

FIG. 16 illustrates an example virtual apparatus, according to certain embodiments;

FIG. 17 illustrates another example method by a wireless device, according to certain embodiments;

FIG. 18 illustrates another example virtual apparatus, according to certain embodiments;

FIG. 19 illustrates an example method by a network node, according to certain embodiments;

FIG. 20 illustrates another virtual apparatus, according to certain embodiments;

FIG. 21 illustrates another example method by a network node, according to certain embodiments; and

FIG. 22 illustrates another example virtual apparatus, according to certain embodiments.

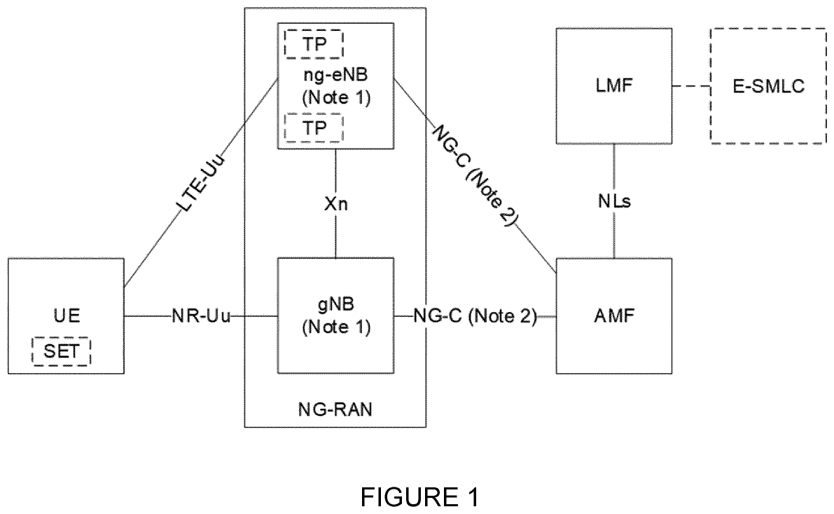

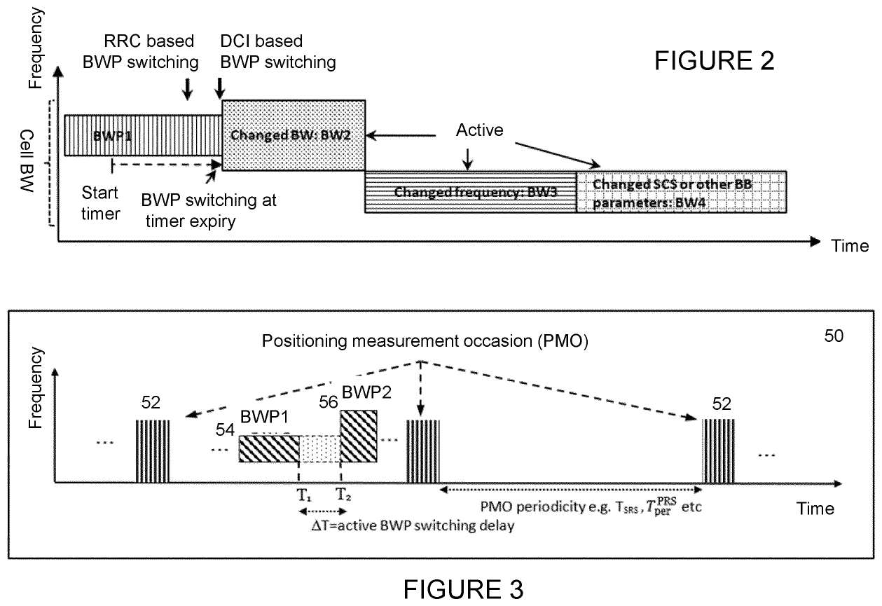

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR base station (MSR BS), eNodeB, gNodeB, network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self-Optimized Network (SON), positioning node (e.g. evolved Serving Mobile Location Center (E-SMLC)), Minimization Drive Test (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, Personal Data Assistant (PDA), Tablet, mobile terminals, smart phone, laptop embedded equipped (LEE), laptop mounted equipment (LME), Universal Serial Bus (USB) dongles, UE category M1, UE category M2, Proximity Services (ProSe) UE, Vehicle-to-vehicle (V2V) UE, Vehicle-to-anything (V2X) UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNB, or UE.

The term radio access technology (RAT), may refer to any RAT e.g. Universal Terrestrial Radio Access (UTRA), Evolved Universal Terrestrial Radio Access (E-UTRA), narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The term signal or radio signal used herein can be any physical signal or physical channel. Examples of DL physical signals are reference signal such as Primary Synchronization Signal (PSS), Secondary Synchronization Signal (SSS), Channel State Information-Reference Signal (CSI-RS), Demodulation Reference Signal (DMRS), signals in SSB, DRS, CRS, PRS etc. Examples of UL physical signals are reference signal such as SRS, DMRS etc. The term physical channel refers to any channel carrying higher layer information e.g. data, control etc. Examples of physical channels are Physical Broadcast Channel (PBCH), Narrowband PBCH (NPBCH), Physical Downlink Control Channel (PDCCH), Physical Downlink Shared Channel (PDSCH), short PUCCH (sPUCCH), short PDSCH (sPDSCH), short Physical Uplink Control Channel (sPUCCH), short Physical Uplink Shared Channel (sPUSCH), MTC Physical Downlink Control Channel (MPDCCH), narrowband PDCCH (NPDCCH), narrowband PDSCH (NPDSCH), Evolved PDCCH (E-PDCCH), PUSCH, PUCCH, narrowband PUSCH (NPUSCH), etc.

The term time resource used herein may correspond to any type of physical resource or radio resource expressed in terms of length of time. Examples of time resources are: symbol, time slot, subframe, radio frame, TTI, interleaving time, slot, sub-slot, mini-slot, etc.

The scenario comprising a UE served by at least one serving cell (cell1) is configured to perform one or more positioning measurements on reference signals (RS) operated by one or more cells on one or more carrier frequencies. The cells for positioning measurements may belong to a set comprising all neighbor cells or comprising all serving cells or comprising serving and neighbor cells, the serving cell (if any) may or may not be the same as cell1. Examples of cell1 are special cell (SpCell), SCell etc. Examples of SpCell are PCell, PSCell etc. Examples of RS used for positioning measurements are PRS, SRS, SSB, CSI-RS etc. The positioning measurement can be performed on one type or multiple types of RS depending on the type of the measurement e.g. RSTD on PRS while UE Rx-Tx time difference on both PRS and SRS, etc.

According to certain embodiments, a UE is autonomously configured to perform positioning measurements such as, for example, for UE based positioning. In other embodiments, the UE is configured to perform the positioning measurements by a network node (NW). In one example embodiment, the NW is a positioning node such as a Location Management Function (LMF), for example. In another example embodiment, the NW is different than the positioning node. For example, it can be a base station serving the UE.

According to certain embodiments, the UE is further configured to switch at least one active bandwidth part (BWP) on at least one serving cell, which may be called a cell1, in an example embodiment. For example the UE may be configured to switch downlink (DL) active BWP on cell1. In another example, the UE may be configured to switch the uplink (UL) active BWP on cell1. In yet another example, the UE may be configured to switch both its DL active BWP and UL active BWP on cell1. The UE may be configured to switch the active BWP(s) based on any of the mechanisms that may include, for example, timer based, DCI based or RRC based BWP switching.

According to certain embodiments, methods, systems, and techniques are provided for defining UE behavior if the active BWP switching impacts or is expected to impact one or more positioning measurement occasions. For example, if the active BWP switching action overlaps or is expected to overlap in time or frequency with at least K (K>0) number of resources in the positioning measurement occasions (or a group of consecutive or closely configured slots with PRS), the UE may take one or more actions. Examples of such actions comprising:
stopping the active BWP switching,
discarding the active BWP switching,
completing the active BWP switching while suspending the positioning measurements or dropping the affected positioning occasion,
delaying the start of the active BWP switching e.g. until the end of measurement occasion,
delaying the start of the active BWP switching e.g. until the end of a measurement gap if measurement occasion is within the gap,
requesting a network node (e.g. base station) to configure measurement gaps if the active BWP switching reduces resources within one or more positioning measurement occasion below certain threshold (H1) e.g. PRS BW of PRS is not within the new BWP, PRS BW of PRS within the new BWP is below certain threshold (e.g., when the old and new active BWPs have the same center frequency but the BW of the new active BWP becomes smaller) etc. The positioning measurement time period or measurement delay may be extended to include the time needed to obtain and start using the necessary measurement gaps.
adapting one or more positioning measurement requirements if the active BWP switching reduces resources within one or more positioning measurement occasion below certain threshold (H2) e.g. at least L number of time resources containing PRS is interrupted.
transmitting information about the impact of the active BWP switching one or more positioning measurements to a network node e.g. to positioning node.
indicating to the network node (e.g. serving node, positioning node) that the active BWP switching procedure has been or will be impacted (by a positioning measurement), e.g., delayed or stopped.

According to certain embodiments, methods, systems, and techniques are provided for a network node receiving information (e.g., from a UE or another NW node, etc.) about an impact or expected impact of the active BWP switching on one or more positioning measurements being performed by the UE. The network node may use the obtained information for taking one or more actions. Examples of actions comprising:
adapting positioning measurement configuration and transmitting the adapted positioning measurement configuration to the UE (this includes also adaptively in time triggering of the configured signals such as SRS transmissions),
reconfiguring the UE with a positioning measurement to alleviate problem due to active BWP switching e.g. with measurements (e.g. RSTD) requiring only PRS if UL active BWP switching impacts the SRS transmission etc.
adapting active BWP switching to avoid interruption to RS configured for positioning measurements (e.g. if the adapting NW node is a base station serving the UE).

FIG. 3 illustrates an example 50 where the UE is configured to perform positioning measurements on signals operating during the positioning measurement occasion (PMO) 52 in one or more cells operating on a carrier frequency (F1), according to certain embodiments. Such cells may include, as one example, a PRS resource set in PRS occasions.

The carrier, F1, may also be called as frequency layer, a positioning frequency layer etc. As shown in FIG. 3, each PMO 52 comprising a set of RS (e.g. PRS, SRS, etc.) with certain bandwidth (e.g. 24 PRBs, 62 PRBs, etc.) and occurs periodically such as, for example, with PRS resource periodicity. The UE may be further configured with one or more muting patterns for reducing interference at the UE. For example, a muting pattern may indicate the muted PMO and/or muted resources (e.g. PRS resource) within certain PMO. A resource indicated as muted is not transmitted by the radio node. The UE may use RS in one or multiple PMO for performing the positioning measurements.

In one example, the UE may be configured with measurement gaps for doing the positioning measurements. For example, the measurement gaps may include periodic gaps where each gap of X1 time resources (e.g. measurement gap length (MGL)) occurs periodically every X2 time resources (e.g. measurement gap repetition period (MGRP)) such as, for example, X1=6 ms and X2=40 ms. In order to enable the UE to perform the positioning measurements, at least M out of N PMOs at least partially lie within the measurement gaps. In a particular embodiment, M may equal N. The measurement gap (e.g. MGL) in a gap pattern may also be referred to as PMO.

In a particular embodiment, the UE may not be configured with measurement gaps for doing the positioning measurements. In this case, in one example, the BW of RS within PMO at least partially lie within the active BWP and, therefore, the UE can measure within the active BWP.

In another particular embodiment, the BW of RS within the active BWP is below threshold and gaps are also not configured. In this case, the UE may autonomously retune its receiver during one or multiple PMO occasions for performing the positioning measurements.

FIG. 3 further shows that at time instance, Ti, the UE is triggered to change its active BWP switching from a first BWP (BWP1) 54 to a new or target BWP, second BWP (BWP2) 56. The triggering instance, T₁, occurs, for example, upon receiving a message or upon expiry of timer, which may be preconfigured. In a particular embodiment, for example, the triggering instance, Ti, occurs upon expiry of BWP inactivity timer (e.g. X3 ms) configured by the BS. The UE completes the active BWP switching from BWP1 54 to BWP2 56 at time instance, T₂, over a duration of ΔT (i.e. ΔT=T₂−T₁). In this example, the BWP switching changes both the BW and the center frequency of the BWP. During ΔT, the UE retunes its receiver and/or transmitter, and uses its resources (e.g. processor, memory, power etc) for processing the active BWP switching procedure. Therefore, during ΔT, the UE is not expected to receive and/or transmit signals This may cause interruption of signals, including reception and/or transmission of signals during PMO.

### Method in UE of Adapting Positioning Measurement Procedure Under Active BWP Switching

According to certain embodiments, the UE configured to perform positioning measurements determines or monitors if the active BWP switching is triggered or is expected to be triggered in at least one serving cell such as, for example, cell1. In a particular embodiment, the determination or monitoring may be based on receiving a message such as, for example, a DCI command and/or internally such as, for example, in response to expiration of a timer. The UE may monitor the triggering of the active BWP switching in one or more serving cells particularly over certain time periods such as, for example, during the PMOs.

In some example embodiments, the PMO may also comprise a transmission occasion where the UE needs to transmit in UL for positioning purpose such as for performing a positioning measurement on UL signals and/or for enabling a radio node (e.g. base station) to perform positioning measurement on signal received from the UE. Examples of transmission occasion comprising duration over which the UE transmits uplink signal, a time resource over the UE transmit UL signal for positioning measurements. UL signals for positioning purposes may include uplink reference signal (UL RS), which may include, for example, DMRS, SRS, etc.

In other example embodiments, the PMO may also comprise a measurement gap if measurement gaps are used by the UE for performing positioning measurements. In this case the signals used for positioning measurements are within the measurement gaps. For example, the measurement gaps are configured in a manner to ensure that reference signal (RS) for positioning such as PRS are within the measurement gaps. This enables the UE to measure the PRS in the gaps. If active BWP switching is triggered anywhere within a duration which is less than D1 time resources before the start of the PMO (e.g. less than 20 slots before the PMO starts), the active BWP switching may spill over or overlap at least partially over the PMO. This is because D1 may correspond to or is function of the time required by the UE to perform the active BWP switching. During the active BWP switching, the UE is not expected to receive and transmit any signal on the serving cell (cell1) where the active BWP is switched. The other cells on the carrier of cell1 and cells on other carriers are also interrupted at least partially during the active BWP switching. For example, assume D1=20 slots and PMO=10 slots. If the active BWP switching is triggered 15 slots before the start of the PMO, at least 5 initial slots of the PMO will be interrupted due to the active BWP switching. The active BWP switching may also involve interruption in one or more serving cells that occur within the active BWP switching delay.

According to certain embodiments, based on the outcome of the monitoring, the UE may take one or more actions. Different steps in the UE are described below with examples:

A. UE Determining Impact of Active BWP Switching on Positioning Measurement

If the UE determines or identifies that the active BWP switching is impacting or is expected to impact one or more PMOs, which the UE may use for the positioning measurements, the UE may adapt one or more procedures (such as those described in TR 3GPP section 5.2.2.1, for example). The impact on PMO due to the active BWP switching may be critical (e.g. severe) or non-critical (e.g. benign). Therefore, the UE may further determine the extent of the impact, in certain embodiments. If the impact is critical, the UE may adapt one or more procedures or certain procedures or take certain actions. If the impact is non-critical, the UE may not adapt any procedure or may not take any action or may take certain actions but without impacting the active BWP switching or positioning measurement procedures. Any impact which is not identified by the UE as critical is regarded as non-critical. Examples of scenarios in which the impact of the active BWP switching on the positioning measurement procedures is considered critical are:
Positioning measurements which are related to emergency positioning or not triggered by a commercial application.
Scenarios in which positioning measurement performance or estimated positioning measurement performance becomes worse than certain threshold (e.g. RSTD accuracy is X4 ns worse than target accuracy) or scenarios in which the UE cannot meet one or more positioning measurement requirements (e.g. cannot measure with the required accuracy within a pre-define measurement time).
Scenarios in which the active BWP switching occurs or is expected to occur at least partially during the PMO interrupting at least certain number of RS resources within the PMO.
Scenarios in which the active BWP switching action overlaps or is expected to overlap with at least K number of resources in the positioning measurement occasions. The K resources (e.g. slots or resource blocks) may be interrupted and prevent the UE from performing the measurement with required accuracy. Examples of resources in PMO are time and/or frequency resources carrying RS include SRS resources, PRS resources, symbols/slots containing PRS, symbols/slots containing SRS, etc.
Scenarios in which after the active BWP switching, the new active BWP (e.g. BWP2) does not fully contain the BW of the RS in the PMO configured/used before the active BWP switching.
Scenarios in which after the active BWP switching, the new active BWP (e.g. BWP2) contains the RS in the PMO with a BW (i.e. of RS) not larger than certain threshold (G1).
Scenario in which the BW of the RS in the PMO within the active BWP changes or is expected to change due to the active BWP switching. For example, the active BWP1 can contain the RS over a first bandwidth (BW1), while the active BWP2 can contain the RS over a second bandwidth (BW2) and where BW1≈BW2.
Scenarios in which BW2 and BW1 differ by at least certain threshold (G2) such as, for example, |BW2-BW1|≥G2. G2 may be pre-defined or configured by the network node.
Scenarios where BW2 is less than BW1 by certain threshold (G3) e.g. critical impact if BW2<(BW1-G3). G3 may be pre-defined or configured by the network node.
Scenarios where BW2 is less than certain threshold (G4) e.g. critical impact if BW2<G4. G4 may be pre-defined or configured by the network node. As an example, G4 may correspond to the bandwidth of RS provided to the UE by the network node (e.g. positioning node) in a positioning measurement configuration e.g. in assistance data.
Scenarios in which the active BWP switching action overlaps or is expected to overlap with at least R1 number or X % of resources in the positioning measurement occasions or R2 number or Y % of PMO and the periodicity of RS (e.g. PMO period) is longer than certain threshold (e.g. 640 slots). The threshold may further depend on the numerology of the RS within PMO. The R1 and R2 resources (e.g. slots or resource blocks) may be interrupted and preventing the UE to perform the measurement with required accuracy.

In yet another particular example, the UE may also apply muting patterns configured for positioning measurements for determining the impact of the active BWP switching. For example, if the active BWP switching occurs during the time which overlaps with PMO which is muted, the UE may assume that the impact of then active BWP switching is non-critical. Otherwise, UE may assume that the impact is critical.

Conversely, when the UE is using measurement gaps and some PMO cannot be received due to gap sharing (e.g., receiving on another frequency), then the impact of active BWP switching to such PMO may be considered non-critical.

B. UE Actions Based on Impact of Active BWP Switching on Positioning Measurement

According to certain embodiments, if the impact of the active BWP switching is determined by the UE to be critical, the UE may perform one or more of the following actions or tasks or operations:
1. Stopping and discarding the active BWP switching: The UE may stop the active BWP switching procedure at any instance or at specific instances. For example it may stop it upon triggering of the active BWP switching (e.g. upon expiry of timer, upon processing message requiring the UE to start the switching etc) or during the active BWP switching procedure (e.g. when it starts to overlap with PMO). This action may also depend on the type of active BWP switching. For example, it may apply for timer-based or RRC based not for DCI based active BWP. The rule can be pre-defined or configured by the network node.
2. Stopping and resuming or restarting the active BWP switching after PMO: The UE may stop the active BWP switching as in example 1 above to prevent or minimize impact on PMO or gap containing PMO (if gaps are used), but the UE may resume or restart the active BWP switching after the end of the PMO or the gap (if used). In summary, the active BWP switching may be suspended temporarily. This action may also depend on the type of active BWP switching and the rule can be pre-defined or configured by the network node.
3. Completing the active BWP switching while suspending the positioning measurements or dropping the affected positioning occasion: The UE may complete the active BWP switching, but the ongoing positioning measurement may be suspended temporarily and then resumed after the completion of the active BWP switching. In this example, the active BWP switching is prioritized over the measurement or, in one example, the active BWP switching is prioritized over the measurement gaps. In one specific example when the PMO comprises a measurement gap, then the UE does not fully or partially use the measurement gap for performing the measurement. Instead, the UE performs the active BWP switching during the time which at least partially overlaps with duration of the measurement gap. The measurement period can be extended to compensate for the dropped occasion. In this case, the UE may be allowed to adapt one or more measurement requirements (e.g. extend measurement time) and meet the adapted measurement requirements as further described in example 5. This action may also depend on the type of active BWP switching and the rule can be pre-defined or configured by the network node.
4. Requesting measurement gaps: If the active BWP switching impact is determined to be critical, the UE may send a message to a network node (e.g. base station) requesting the network node to configure the UE with measurement gap pattern for positioning measurements. In another example, the active BWP switching itself may change the positioning measurement type (e.g., the center frequency changes and the measurement can become inter-frequency or intra-frequency but requiring gaps) and hereby trigger measurement gap request by the UE. In yet another example, if the existing gap pattern configured for measurements is not suitable, the UE may request another measurement gap pattern (e.g. with larger gap duration e.g. MGL>10 ms). For example, the UE may request the gap pattern or request another one if the active BWP switching reduces resources within one or more positioning measurement occasion below certain threshold (H1). For example, the UE may request gap pattern if PRS BW of PRS is not fully within the new active BWP or PRS BW of PRS within the new active BWP is below certain threshold, etc. Upon being configured with gaps (based on UE requests), the UE may further be allowed to restart the positioning upon configured with the measurement gaps (e.g. the UE may be allowed to discard the previous measurement samples (taken before receiving the gaps or the new gap) and take new samples during the gaps). In this case, the UE may also be allowed to adapt one or more measurement requirements (e.g. extend measurement time) and meet the adapted measurement requirements as further described in example 5. This action may also depend on the type of active BWP switching and the rule can be pre-defined or configured by the network node. The positioning measurement delay may be extended to include the time needed for the UE to obtain and start using the necessary measurement gap configuration.
5. Adapting measurement requirement: The UE may adapt one or more positioning measurement requirements if the active BWP switching results in loss or interruption or reduction of resources within one or more PMOs below certain threshold (H2) e.g. at least L number of time resources containing RS in PMO is interrupted. The UE may then be allowed to meet the adapted positioning measurement requirements. In another example, the UE may be allowed to meet a more relaxed requirement out of those applicable before and after active BWP switching. Examples of requirements are measurement time of the measurement (e.g. RSTD measurement period), measurement accuracy of the measurement, number of carriers and/or cells to be measured, signal level down to which the measurement is to be performed, measurement rate (i.e. how often the measurement is done e.g. once every Qth DRX cycle), etc. Examples of measurement time are cell detection time, physical layer (L1) measurement period, and evaluation period. The requirements are based on one or more rules, which can be pre-defined (e.g. specified in the standard) and/or configured by the network node.
   One example of the adaptation of the positioning measurement requirement may correspond to performing positioning measurement over an extended measurement time (Te) instead over basic or reference or legacy measurement time (Tb); where Te>Tb. The UE may be required to perform the measurement over Tb if the active BWP switching does not critically impact any PMO used by the UE for positioning measurement. Te and Tb may be related by a function e.g. Te=f(Tb, P); where P is number of time resources (Nr) with RS or number (Np) of PMO interrupted or cannot be used due to the active BWP switching. In one specific example: Te=Tb+P*Nr or Te=Tb+P*Np.
   Another example of the adaptation of the positioning measurement requirement may correspond to performing positioning measurement while meeting relax measurement accuracy (Ar) instead of meeting better or reference or legacy measurement accuracy (Ab); where Ar<Ab e.g. Ar=±128 ns while Ar=±64 ns. The UE may be required to perform the measurement while meeting Ab if the active BWP switching does not critically impact any PMO used by the UE for positioning measurement.
6. Transmitting information to network node: The UE may further transmit one or more of the following sets of information to the network node:
   Information about the determined impact of the active BWP switching to one or more positioning measurements to a network node such as, for example, a positioning node, base station, etc. For example the UE may inform any of the determined impact (critical or non-critical) described above. In a particular embodiment, the UE may inform a network node that there has been an impact of the active BWP to one or more positioning measurements without a specific indication of the type, or severity of impact. For example the indication may inform that the measurement results reported to the network node is unreliable since BWP switching occurred during the measurement. As an example, unreliable measurement result may imply that the UE may not meet at least one of the measurement requirements such as, for example, when measurement accuracy is worse than a certain threshold, when the measurements will be performed on a number of cells that is below a certain threshold, and when measurement may be performed over a period longer than a certain threshold. The network node may decide whether to use the unreliable results for determining the positioning or not. For example, the network node may not use the unreliable results if the measurement is used for determining the UE positioning for critical services (e.g. emergency call); otherwise, the network node may use it for positioning determination.
   Information about any action the UE has taken based on the determined impact (e.g. above examples 1-5)
   Information indicating to the network node (e.g. positioning node, serving node) that the active BWP switching procedure has been or will be impacted (by a positioning measurement), e.g., delayed or stopped.
      Method in a Network Node of Receiving Information about Impact of Active BWP Switching and Performing Tasks

According to certain embodiments, the network node (e.g. first network node (NW1)) may receive information impact of the active BWP switching one or more positioning measurements performed or expected to be performed by the UE and/or information about the actions taken by the UE and based on the received information it may perform one or more tasks or operations. The network node such as, for example, first network node (NW1), may receive the above information from the UE or from another network node such as, for example, second network node (NW2). For example, if NW1 is a positioning node, it may receive information from the UE or from a base station (i.e. NW2) serving the UE. In another example, if NW1 is a base station serving the UE, it may receive information from the UE or the positioning node (i.e. NW2).

Examples of tasks which can be performed by NW1 comprising one or more of the following:
Adapting positioning measurement configuration: For example NW1 (e.g. LMF) may modify one or more parameters in the measurement configuration (e.g. in assistance data) and transmit the adapted positioning measurement configuration to the UE. For example, to minimize the impact of active BWP switching, the adaptation may comprise changing the RS bandwidth and/or RS periodicity and/or number of time resources containing RS within PMO. In one specific example, it may increase the bandwidth of RS above certain threshold and/or reduce the periodicity of RS below certain threshold and/or increase number of time resources containing RS within PMO above certain threshold. In another example, the adapting of the positioning measurement configuration may also comprise triggering adaptively in time of the configured signals such as SRS transmissions (e.g. delayed or earlier triggering or triggering another SRS instance to avoid or reduce the impact, etc.).
Changing positioning measurement: For example, NW1 may reconfigure the UE with a type of positioning measurement different than the type of the currently configured measurement to alleviate problem due to active BWP switching. For example, NW1 may select the new measurement type which will have no or less impact of active BWP switching on the positioning measurement. For example, NW1 may requests the UE to start performing certain measurement (e.g. RSTD) and stop performing UE Rx-Tx time difference. This is because in former PRS is impacted due to only DL active BWP switching while in the latter PRS and SRS are impacted by DL and UL active BWP switching, respectively. In TDD, the PRS and SRS resources are configured in different slots and, therefore, DL and UL active BWP switching may impact PRS and SRS, respectively.
Adapting active BWP switching: In one example, NW1 may configure the UE with active BWP switching during period that does not contain any RS that can be used by the UE for positioning such as, for example, in between successive PMOs. This action applies to NW1 if it is a base station serving the UE.
Adapting the BWP assumed to be used by the UE: In one example, NW1 (e.g. base station) may assume due to information received from the UE or NW2 (e.g. LMF) that the UE is not operating with the active downlink or uplink BWP it would otherwise be expected to be operating with. A specific example is when a UE stops a BWP switch and then discards or resumes the BWP switch. If NW1 is aware that the UE has stopped and discarded the BWP switch, or stopped and will resume the BWP switch, NW1 may schedule the UE with the assumption that the UE is still using a different BWP such as the BWP from before the switching, rather than the BWP that would be expected to be used based on the switching. For instance, if NW1 issues a DCI command to switch active DL BWP but then receives information that the UE is performing positioning measurements and stopped the BWP switch either temporarily or indefinitely, NW1 may continue to schedule the UE with the former DL BWP.
Repeating the positioning measurement: In one example, NW1 (e.g. LMF) may request a UE to repeat a measurement based on the information received about the impact of BWP switching on one or more positioning measurements and/or information about the actions taken by the UE. In one specific example, the indication of the first positioning measurement indicates that the first positioning measurement is unreliable due to BWP switching. In response, NW1 may request the measurement to be repeated. If BWP switching is infrequent, there is a good chance that no BWP switch will occur during a second or subsequent attempt to perform the positioning measurement.
Providing or triggering the use of aperiodic positioning resource to compensate for the impact: In one example, if some of the periodic resources got impacted by the active BWP switching, the network node may provide or trigger the use of aperiodic positioning resources (UL and/or DL) to compensate for the impact.
Ensuring that active BWP switching does not occur later than time delta before the PMO: Active BWP switching configuration may be adapted to PMO configuration when the PMO configuration is known or can be determined.

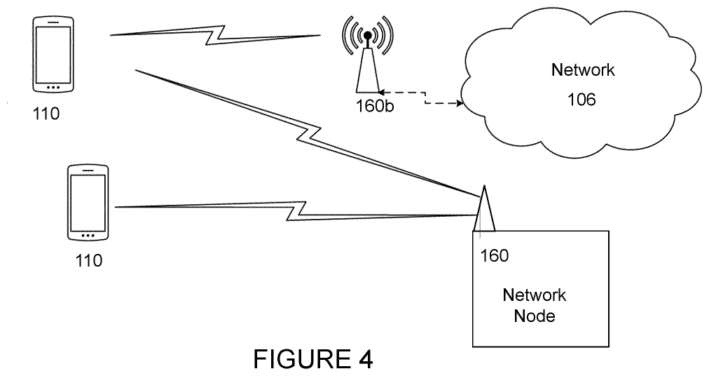

FIG. 4 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 4. For simplicity, the wireless network of FIG. 4 only depicts network 106, network nodes 160 and 160b, and wireless devices 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and wireless device 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

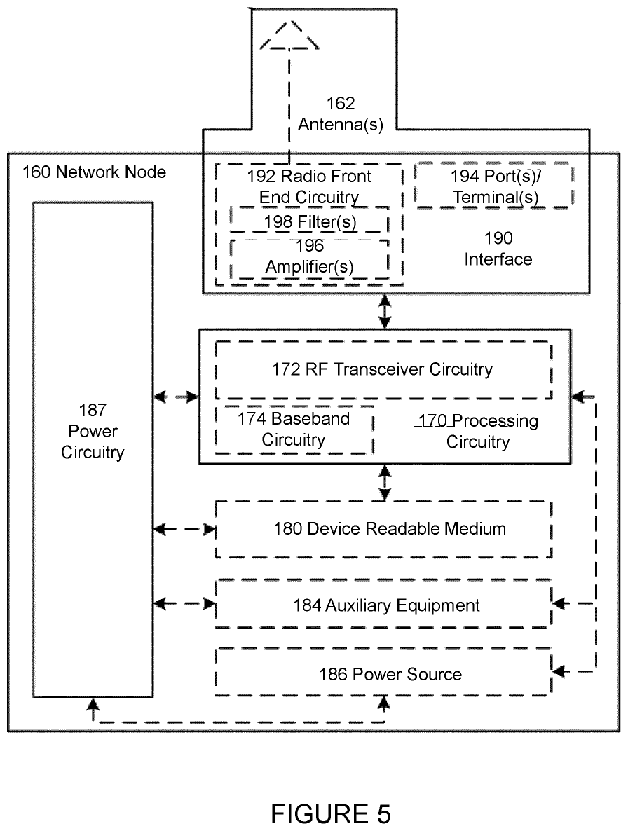

FIG. 5 illustrates an example network node 160, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 5, network node 160 includes processing circuitry 170, device readable medium 180, interface 190, auxiliary equipment 184, power source 186, power circuitry 187, and antenna 162. Although network node 160 illustrated in the example wireless network of FIG. 5 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or wireless devices 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or wireless devices via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 5 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

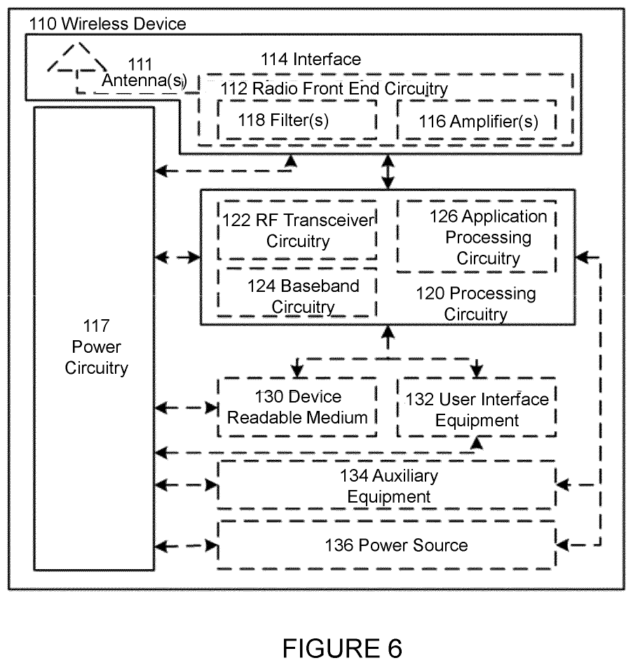

FIG. 6 illustrates an example wireless device 110. According to certain embodiments. As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. Wireless device 110 may include multiple sets of one or more of the illustrated components for different wireless technologies supported by wireless device 110, such as, for example, GSM, WCDMA, LTE, NR, WiFi, WiMAX, or Bluetooth wireless technologies, just to mention a few. These wireless technologies may be integrated into the same or different chips or set of chips as other components within wireless device 110.

Antenna 111 may include one or more antennas or antenna arrays, configured to send and/or receive wireless signals, and is connected to interface 114. In certain alternative embodiments, antenna 111 may be separate from wireless device 110 and be connectable to wireless device 110 through an interface or port. Antenna 111, interface 114, and/or processing circuitry 120 may be configured to perform any receiving or transmitting operations described herein as being performed by a wireless device. Any information, data and/or signals may be received from a network node and/or another wireless device. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, wireless device 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or wireless devices via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 110 components, such as device readable medium 130, wireless device 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of wireless device 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a wireless device may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of wireless device 110, but are enjoyed by wireless device 110 as a whole, and/or by end users and the wireless network generally.

Processing circuitry 120 may be configured to perform any determining, calculating, or similar operations (e.g., certain obtaining operations) described herein as being performed by a wireless device. These operations, as performed by processing circuitry 120, may include processing information obtained by processing circuitry 120 by, for example, converting the obtained information into other information, comparing the obtained information or converted information to information stored by wireless device 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with wireless device 110. Such interaction may be of many forms, such as visual, audial, tactile, etc. User interface equipment 132 may be operable to produce output to the user and to allow the user to provide input to wireless device 110. The type of interaction may vary depending on the type of user interface equipment 132 installed in wireless device 110. For example, if wireless device 110 is a smart phone, the interaction may be via a touch screen; if wireless device 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into wireless device 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from wireless device 110, and to allow processing circuitry 120 to output information from wireless device 110. User interface equipment 132 may include, for example, a speaker, a display, vibrating circuitry, a USB port, a headphone interface, or other output circuitry. Using one or more input and output interfaces, devices, and circuits, of user interface equipment 132, wireless device 110 may communicate with end users and/or the wireless network and allow them to benefit from the functionality described herein.

Auxiliary equipment 134 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. wireless device 110 may further comprise power circuitry 137 for delivering power from power source 136 to the various parts of wireless device 110 which need power from power source 136 to carry out any functionality described or indicated herein. Power circuitry 137 may in certain embodiments comprise power management circuitry. Power circuitry 137 may additionally or alternatively be operable to receive power from an external power source; in which case wireless device 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of wireless device 110 to which power is supplied.

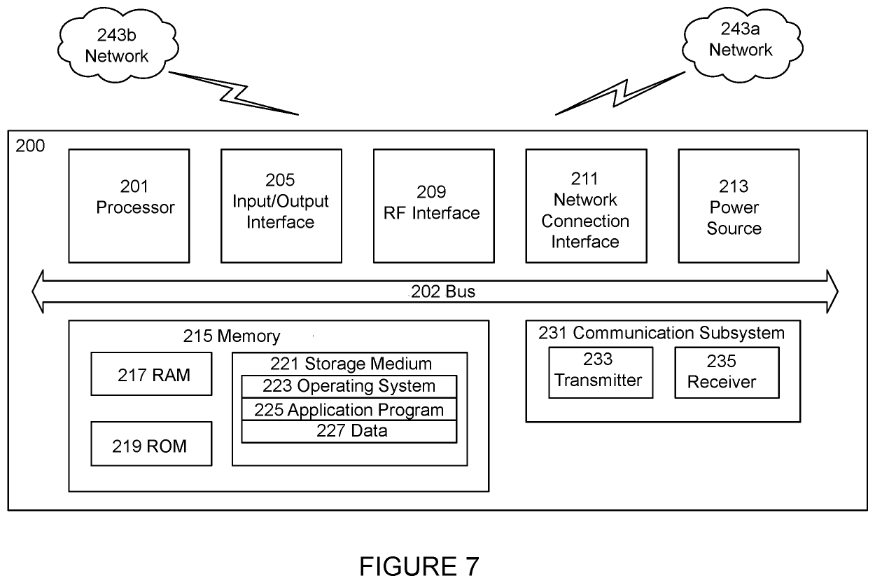

FIG. 7 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 5, is one example of a wireless device configured for communication in accordance with one or more communication standards promulgated by the 3r^{d} Generation Partnership Project (3GPP), such as 3GPP's GSM, UMTS, LTE, and/or 5G standards. As mentioned previously, the term wireless device and UE may be used interchangeable. Accordingly, although FIG. 7 is a UE, the components discussed herein are equally applicable to a wireless device, and vice-versa.

In FIG. 7, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 7, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another wireless device, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

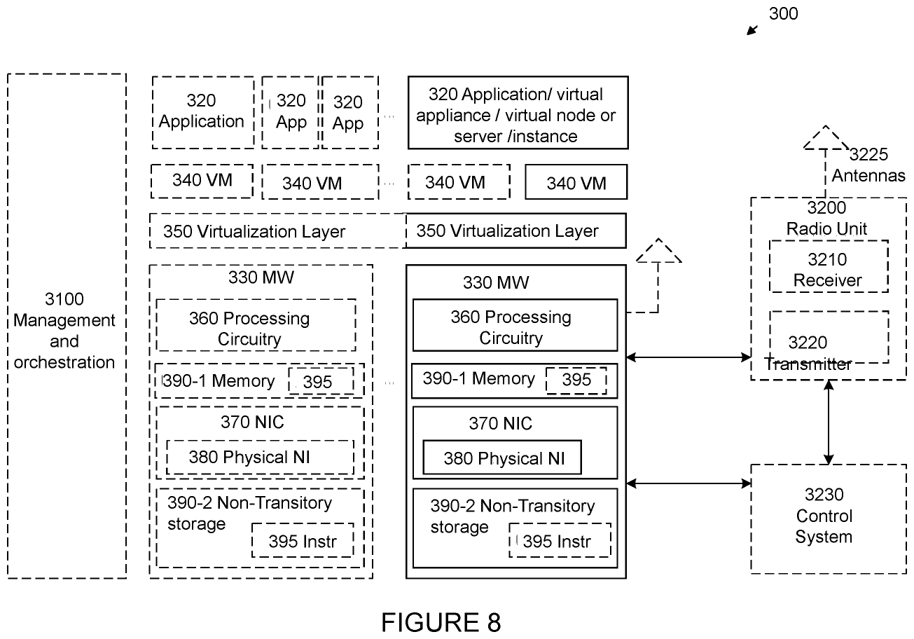

FIG. 8 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 8, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 8.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be affected with the use of control system 3230 which may alternatively be used for communication between the hardware nodes 330 and radio units 3200.

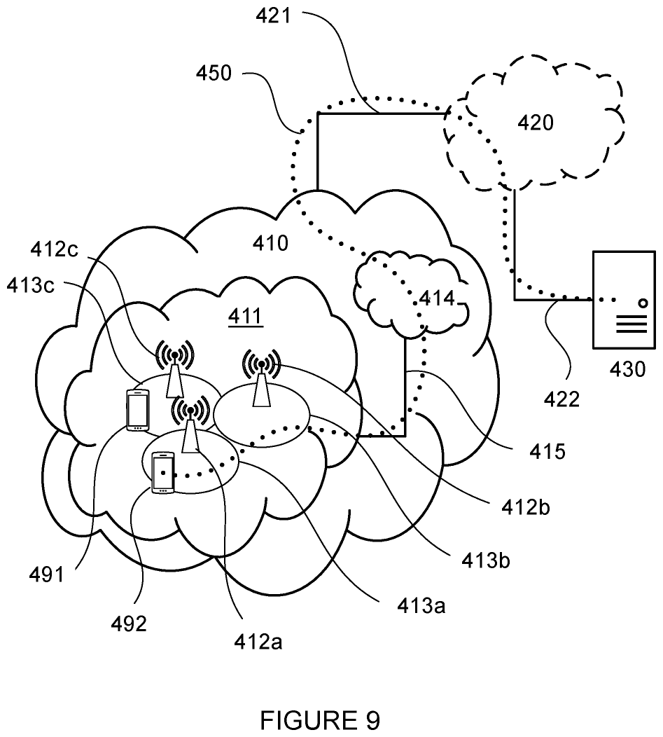

FIG. 9 illustrates a telecommunication network connected via an intermediate network to a host computer in accordance with some embodiments.

With reference to FIG. 9, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 9 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

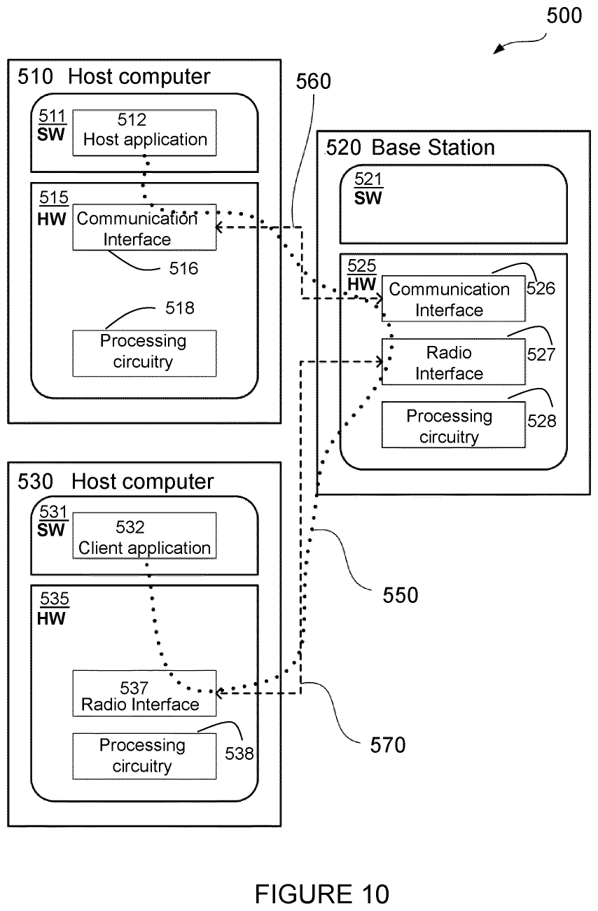

FIG. 10 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 10. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 10) served by base station 520. Communication interface 526 may be configured to facilitate connection 560 to host computer 510. Connection 560 may be direct or it may pass through a core network (not shown in FIG. 10) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 10 may be similar or identical to host computer 430, one of base stations 412a, 412b, 412c and one of UEs 491, 492 of FIG. 9, respectively. This is to say, the inner workings of these entities may be as shown in FIG. 10 and independently, the surrounding network topology may be that of FIG. 9.

In FIG. 10, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510′s measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

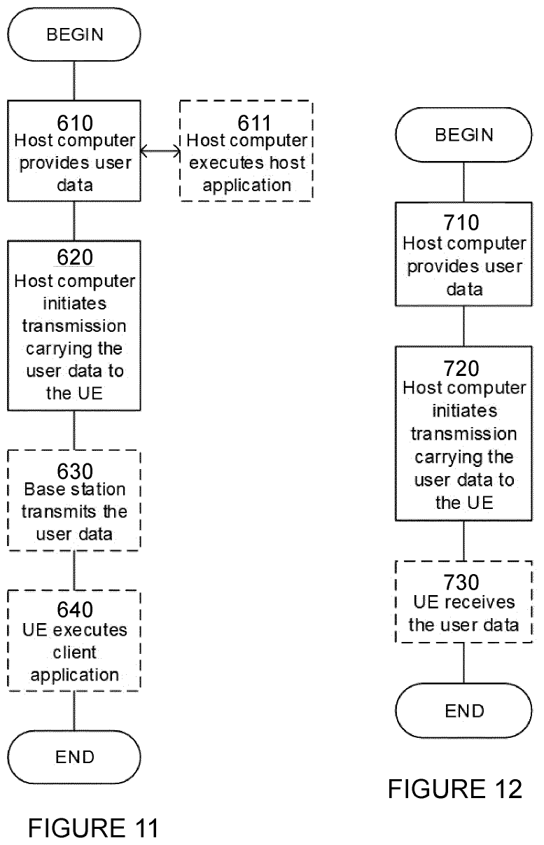

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

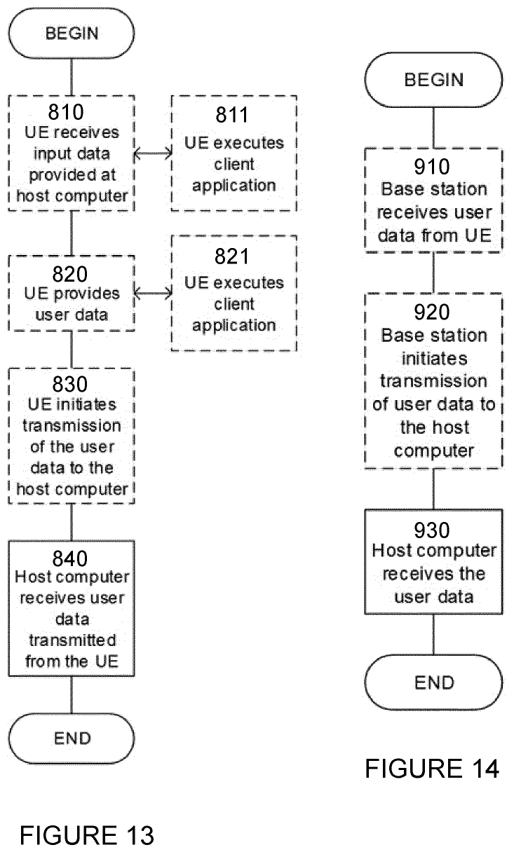

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

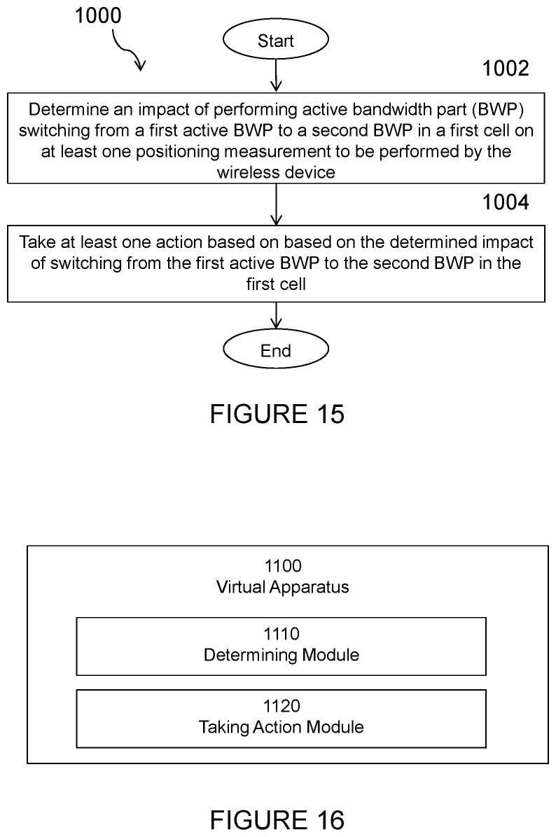

FIG. 15 depicts a method 1000 performed by a wireless device 110, according to certain embodiments. At step 1002, the wireless device 110 determines an impact of performing active BWP switching from a first active BWP to a second BWP in a first cell on at least one positioning measurement to be performed by the wireless device. At step 1004, the wireless device 110 takes at least one action based on based on the determined impact of switching from the first active BWP to the second BWP in the first cell.

FIG. 16 illustrates a schematic block diagram of a virtual apparatus 1100 in a wireless network (for example, the wireless network shown in FIG. 4). The apparatus may be implemented in a wireless device or network node (e.g., wireless device 110 or network node 160 shown in FIG. 4). Apparatus 1100 is operable to carry out the example method described with reference to FIG. 15 and possibly any other processes or methods disclosed herein. It is also to be understood that the method of FIG. 15 is not necessarily carried out solely by apparatus 1100. At least some operations of the method can be performed by one or more other entities.

Virtual Apparatus 1100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause determining module 1110, taking action module 1120, and any other suitable units of apparatus 1100 to perform corresponding functions according one or more embodiments of the present disclosure.

According to certain embodiments, determining module 1110 may perform certain of the determining functions of the apparatus 1100. For example, determining module 1110 may determine an impact of performing active BWP switching from a first active BWP to a second BWP in a first cell on at least one positioning measurement to be performed by the wireless device.

According to certain embodiments, taking action module 1120 may perform certain of the taking action functions of the apparatus 1100. For example, taking action module 1120 may take at least one action based on based on the determined impact of switching from the first active BWP to the second BWP in the first cell.

As used herein, the term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

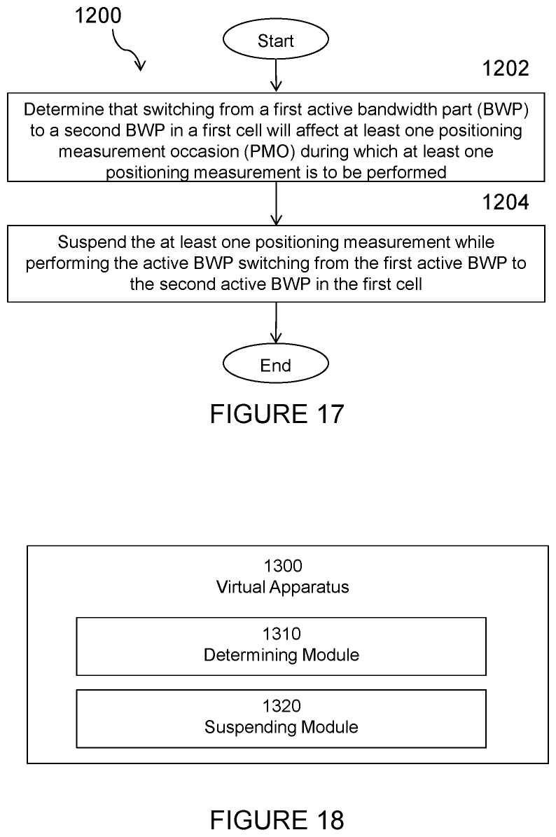

FIG. 17 depicts a method 1200 performed by a wireless device 110, according to certain embodiments. At step 1202, the wireless device 110 determines that switching from a first active BWP to a second BWP in a first cell will affect at least one PMO during which at least one positioning measurement is to be performed. At step 1204, the wireless device 110 suspends the at least one positioning measurement while performing the active BWP switching from the first active BWP to the second active BWP in the first cell.

In a particular embodiment, determining that switching from the first active BWP to the second BWP will affect at least one PMO during which at least one positioning measurement is to be performed includes determining that the wireless device will not meet at least one requirement associated with the at least one positioning measurement.

In a further particular embodiment, the at least one requirement includes one or more positioning measurement requirements for performing the at least one positioning measurement by the wireless device 110.

In a further particular embodiment, the wireless device 110 performs at least one of: adapting the at least one requirement associated with the at least one positioning measurement; relaxing the at least one requirement associated with the at least one positioning measurement; extending a measurement time associated with the at least one positioning measurement; and relaxing an accuracy requirement associated with the at least one positioning measurement.

In a particular embodiment, determining that switching from the first active BWP to the second BWP will affect at least one PMO during which at least one positioning measurement is to be performed includes determining that the switch from the first active BWP to the second active BWP occurs during at least a portion of the at least one PMO.

In a particular embodiment, prior to determining the effect of switching from the first active BWP to the second active BWP, the wireless device 110 determines that the active BWP switching from the first active BWP to the second BWP has been or will be triggered in the first cell based on: at least one message received from a network node, or an expiration of a timer.

In a particular embodiment, the wireless device 110 monitors the first cell during the at least one PMO. The determining step of step 1202 may be based on the monitoring of the first cell. In a further particular embodiment, the at least one PMO comprises at least one measurement gap for performing the at least one positioning measurement.

In a particular embodiment, determining that switching from the first active BWP to the second BWP in the first cell will affect at least one PMO includes determining a level of impact on the at least one PMO expected by switching from the first active BWP to the second BWP in the first cell. In a further particular embodiment, the level of impact is determined to be critical and/or severe in response to a determination of at least one of: the at least one at least one positioning measurement comprises an emergency positioning measurement that will not be triggered in response to the switch from the first active BWP to the second active BWP; an estimated accuracy of performing the at least one positioning measurement is below a first threshold; the wireless device will not meet at least one requirement associated with the at least one positioning measurement; the switch from the first active BWP to the second active BWP occurs during at least a portion of a PMO; the switch from the first active BWP to the second active BWP will interrupt at least one reference signal (RS) resource within a PMO; the switch from the first active BWP to the second active BWP will overlap with at least a number of RS resources; the second active BWP does not fully contain the bandwidth of a RS in a PMO associated with the first active BWP; the second active BWP contains a RS in a PMO with a bandwidth not larger than a second threshold; a bandwidth containing a RS for the first active BWP is different than a bandwidth containing a RS for the second active BWP; a bandwidth associated with the second active BWP is less than a bandwidth associated with the first active BWP by more than a third threshold (BW2<(BW1−T₃); a bandwidth associated with the second active BWP differs from a bandwidth associated with the first active BWP by more than a fourth threshold (|BW2−BW1|>=T₄); a bandwidth associated with the second active BWP is less than a fifth threshold (BW2<T₅); the switch from the first active BWP to the second active BWP will overlap with at least a number of RS resources (R1) or X % of resources in at least one PMO; the switch from the first active BWP to the second active BWP will overlap with at least a number of RS resources (R2) or Y % of resources in at least one PMO and the periodicity of the at least one PMO is longer than a sixth threshold; and the switch from the first active BWP to the second active BWP will occur during a time period that overlaps with a muted PMO.

In a particular embodiment, the wireless device 110 transmits a request to a network node 160 for a measurement gap configuration for performing the at least one positioning measurement. In a further particular embodiment, the wireless device 110 restarts the at least one positioning measurement and meeting at least one requirement for performing the at least one positioning measurement with measurement gaps.

In a particular embodiment, the wireless device 110 transmits information indicating that the wireless device 110 has suspended the at least one positioning measurement while performing the active BWP switching from the first active BWP to the second active BWP.

In a particular embodiment, the wireless device 110 is served by at least one serving cell and the first cell is a cell within the at least one serving cell.

In a particular embodiment, the wireless device 110 is served by at least one serving cell and the first cell is not a cell within the at least one serving cell. In a particular embodiment, the wireless device 110 is configured to perform positioning measurements for a set of cells and the first cell is within the set of cells, and the set of cells comprises a set of serving cells or a set of neighboring cells.

In a particular embodiment, the at least one positioning measurement comprises at least one of: a RSTD, a PRS-RSRP, a PRS-RSRQ, a UE Rx-Tx time difference, a SS-RSRP, a SS-RSRQ, a CSI-RSRP; a CSI-RSRQ, and a RSSI.

FIG. 18 illustrates a schematic block diagram of a virtual apparatus 1300 in a wireless network (for example, the wireless network shown in FIG. 4). The apparatus may be implemented in a wireless device or network node (e.g., wireless device 110 or network node 160 shown in FIG. 4). Apparatus 1300 is operable to carry out the example method described with reference to FIG. 17 and possibly any other processes or methods disclosed herein. It is also to be understood that the method of FIG. 17 is not necessarily carried out solely by apparatus 1300. At least some operations of the method can be performed by one or more other entities.

Virtual Apparatus 1300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause determining module 1310, suspending module 1320, and any other suitable units of apparatus 1300 to perform corresponding functions according one or more embodiments of the present disclosure.

According to certain embodiments, determining module 1310 may perform certain of the determining functions of the apparatus 1300. For example, determining module 1310 may determine that switching from a first active BWP to a second BWP in a first cell will affect at least one PMO during which at least one positioning measurement is to be performed.

According to certain embodiments, suspending module 1320 may perform certain of the suspending functions of the apparatus 1300. For example, suspending module 1320 may suspend the at least one positioning measurement while performing the active BWP switching from the first active BWP to the second active BWP in the first cell.

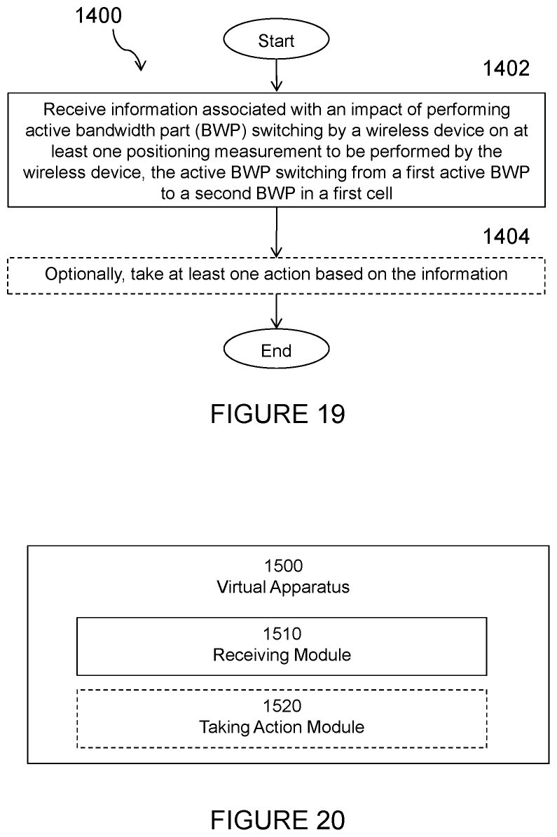

FIG. 19 depicts a method 1400 by a network node 160, according to certain embodiments. At step 1402, the network node 160 receives information associated with an impact of performing active BWP switching by a wireless device 110 on at last one positioning measurement to be performed by the wireless device, the active BWP switching from a first active BWP to a second BWP in a first cell. Optionally, the network node 160 may take at least one action based on the information, at step 1404.

FIG. 20 illustrates a schematic block diagram of a virtual apparatus 1500 in a wireless network (for example, the wireless network shown in FIG. 4). The apparatus may be implemented in a wireless device or network node (e.g., wireless device 110 or network node 160 shown in FIG. 4). Apparatus 1500 is operable to carry out the example method described with reference to FIG. 19 and possibly any other processes or methods disclosed herein. It is also to be understood that the method of FIG. 19 is not necessarily carried out solely by apparatus 1500. At least some operations of the method can be performed by one or more other entities.

Virtual Apparatus 1500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 1510 and, optionally, taking action module 1520 and any other suitable units of apparatus 1500 to perform corresponding functions according one or more embodiments of the present disclosure.

According to certain embodiments, receiving module 1510 may perform certain of the receiving functions of the apparatus 1500. For example, receiving module 1510 may receive information associated with an impact of performing active BWP switching by a wireless device on at last one positioning measurement to be performed by the wireless device. The active BWP switching may be from a first active BWP to a second BWP in a first cell.

According to certain embodiments, optional taking action module 1520 may perform certain of the taking action functions of the apparatus 1500. For example, taking action module 1520 may take at least one action based on the information.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

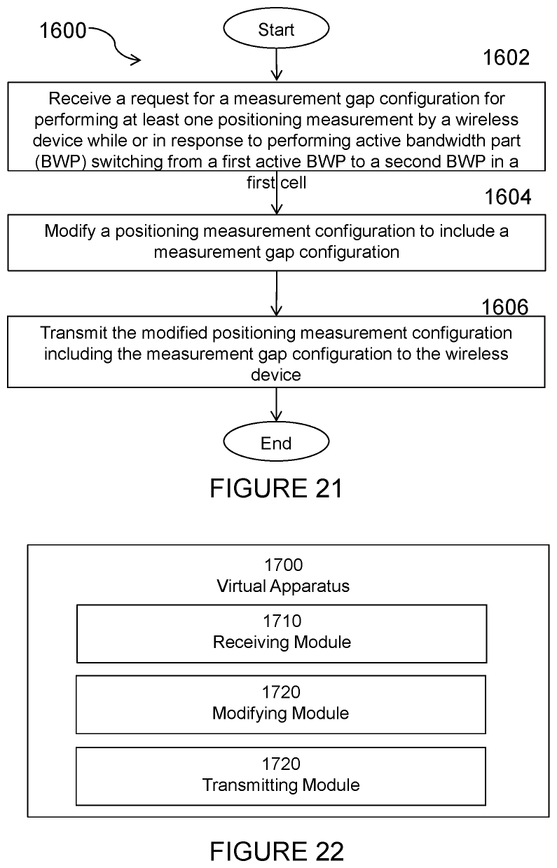

FIG. 21 depicts a method 1600 by a network node 160, according to certain embodiments. At step 1602, the network node 160 receives a request for a measurement gap configuration for performing at least one positioning measurement by a wireless device 110 while or in response to performing active BWP switching from a first active BWP to a second BWP in a first cell. At step 1604, the network node 160 modifies a positioning measurement configuration to include a measurement gap configuration. At step 1606, the network node 160 transmits the modified positioning measurement configuration including the measurement gap configuration to the wireless device 110.

In a particular embodiment, the network node 160 takes at least one action, which may include at least one of: changing a RS bandwidth and/or a RS periodicity and/or a number of time resources containing RS within a PMO; increasing a bandwidth of RS above certain threshold; reducing a periodicity of RS below certain threshold; increasing a number of time resources containing RS within PMO above certain threshold; delaying a RS; triggering a RS early; triggering an additional RS instance to avoid or reduce the impact; changing a type of the at least one positioning measurement to avoid or reduce the impact; adapting the active BWP switching to a time period that does not contain any RS to be used by the wireless device for performing the at least one positioning measurement; adapting the active BWP switching assumed to be used by the wireless device; configuring the wireless device to repeat the at least one positioning measurement; configuring the wireless device to use aperiodic positioning resources to compensate for the impact; and adapting an adaptive BWP switching configuration to a PMO configuration to ensure that the active BWP switching does not occur later than a threshold amount before the PMO.

In a particular embodiment, the network node 160 transmits information associated with the at least one action taken by the network node to the wireless device 110.

In a particular embodiment, the request is received from the wireless device 110. In a further particular embodiment, the network node 160 is a positioning node or a base station serving the wireless device 110.

In a particular embodiment, the request is received from another network node. In a further particular embodiment, the network node 160 includes a positioning node and the other network node includes a base station serving the wireless device 110. In another particular embodiment, the network node 160 comprises a base station serving the wireless device 110 and the other network node comprises a positioning node.

In a particular embodiment, the network node 160 configures the wireless device 110 to: determine whether switching from the first active BWP to the second BWP will affect at least one PMO during which the at least one positioning measurement is to be performed; in response to determining that switching from the first active BWP to the second BWP will affect the at least one PMO, suspend the at least one positioning measurement while performing the active BWP switching from the first active BWP to the second active BWP; and transmit the request for the measurement gap configuration for performing at least one positioning measurement by a wireless device 110.

In a further particular embodiment, configuring the wireless device 110 to determine whether switching from the first active BWP to the second BWP will affect the at least one PMO during which the at least one positioning measurement is to be performed includes configuring the wireless device 110 to determine a level of impact on the at least one PMO expected by switching from the first active BWP to the second BWP in the first cell.

In a further particular embodiment, the level of impact is determined to be critical and/or severe in response to determining at least one of: the at least one at least one positioning measurement comprises an emergency positioning measurement that will not be triggered in response to the switch from the first active BWP to the second active BWP; an estimated accuracy of performing the at least one positioning measurement is below a first threshold; the wireless device will not meet at least one requirement associated with the at least one positioning measurement; the switch from the first active BWP to the second active BWP occurs during at least a portion of a PMO; the switch from the first active BWP to the second active BWP will interrupt at least one reference signal (RS) resource within a PMO; the switch from the first active BWP to the second active BWP will overlap with at least a number of RS resources; the second active BWP does not fully contain the bandwidth of a RS in a PMO associated with the first active BWP; the second active BWP contains a RS in a PMO with a bandwidth not larger than a second threshold; a bandwidth containing a RS for the first active BWP is different than a bandwidth containing a RS for the second active BWP; a bandwidth associated with the second active BWP is less than a bandwidth associated with the first active BWP by more than a third threshold (BW2<(BW1−T₃); a bandwidth associated with the second active BWP differs from a bandwidth associated with the first active BWP by more than a fourth threshold (|BW2−BW1|>=T₄); a bandwidth associated with the second active BWP is less than a fifth threshold (BW2<T₅); the switch from the first active BWP to the second active BWP will overlap with at least a number of RS resources (R1) or X % of resources in at least one PMO; the switch from the first active BWP to the second active BWP will overlap with at least a number of RS resources (R2) or Y % of resources in at least one PMO and the periodicity of the at least one PMO is longer than a sixth threshold; and the switch from the first active BWP to the second active BWP will occur during a time period that overlaps with a muted PMO.

In a particular embodiment, the network node 160 transmits at least one message to the wireless device to trigger the active BWP switching. In a further particular embodiment, the at least one message comprises a downlink control information (DCI) message.

In a particular embodiment, the wireless device 110 is served by at least one serving cell and the first cell is a cell within the at least one serving cell.

In a particular embodiment, the wireless device 110 is served by at least one serving cell and the first cell is not a cell within the at least one serving cell.

In a particular embodiment, the wireless device 110 is configured to perform positioning measurements for a set of cells and the first cell is within the set of cells. In a further particular embodiment, the set of cells comprises a set of serving cells. In a further particular embodiment, the set of cells comprises a set of neighboring cells.

FIG. 22 illustrates a schematic block diagram of a virtual apparatus 1700 in a wireless network (for example, the wireless network shown in FIG. 4). The apparatus may be implemented in a wireless device or network node (e.g., wireless device 110 or network node 160 shown in FIG. 4). Apparatus 700 is operable to carry out the example method described with reference to FIG. 21 and possibly any other processes or methods disclosed herein. It is also to be understood that the method of FIG. 21 is not necessarily carried out solely by apparatus 1700. At least some operations of the method can be performed by one or more other entities.

Virtual Apparatus 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 1710, modifying module 1720, transmitting module 1730, and any other suitable units of apparatus 1700 to perform corresponding functions according one or more embodiments of the present disclosure.

According to certain embodiments, receiving module 1710 may perform certain of the receiving functions of the apparatus 1700. For example, receiving module 1710 may receive a request for a measurement gap configuration for performing at least one positioning measurement by a wireless device 110 while or in response to performing active BWP switching from a first active BWP to a second BWP in a first cell.

According to certain embodiments, modifying module 1720 may perform certain of the modifying functions of the apparatus 1700. For example, modifying module 1720 may modify a positioning measurement configuration to include a measurement gap configuration.

According to certain embodiments, transmitting module 1730 may perform certain of the transmitting functions of the apparatus 1700. For example, transmitting module 1730 may transmit the modified positioning measurement configuration including the measurement gap configuration to the wireless device 110.

### EXAMPLE EMBODIMENTS

Example Embodiment 1. A method performed by a wireless device, the method comprising: determining an impact of performing active bandwidth part (BWP) switching from a first active BWP to a second BWP in a first cell on at least one positioning measurement to be performed by the wireless device; and taking at least one action based on based on the determined impact of switching from the first active BWP to the second BWP in the first cell.

Example Embodiment 2. The method of Example Embodiment 1, further comprising: prior to determining the impact, determining that the active BWP switching from the first active BWP to the second BWP has been or will be triggered in the first cell.

Example Embodiment 3. The method of Example Embodiment 2, wherein determining that the active BWP switching is or will be triggered is based on receiving at least one message from a network node.

Example Embodiment 4. The method of Example Embodiment 3, wherein the at least one message comprises a downlink control information (DCI) message.

Example Embodiment 5. The method of Example Embodiment 2, wherein determining that the active BWP switching is or will be triggered is based on an expiration of a timer.

Example Embodiment 6. The method of any one of Example Embodiments 1 to 5, further comprising monitoring the first cell and wherein the determining step is based on the monitoring of the first cell.

Example Embodiment 7. The method of Example Embodiment 6, wherein monitoring the first cell comprises monitoring the first cell during at least one positioning measurement occasion (PMO).

Example Embodiment 8. The method of Example Embodiment 7, wherein the PMO comprises a measurement gap for performing the at least one positioning measurement.

Example Embodiment 9. The method of any one of Example Embodiments 1 to 8, wherein determining the impact of switching from the first active BWP to the second BWP in the first cell comprises: determining that the switching from the first active BWP to the second BWP will affect at least one PMO during which the at least one positioning measurement is to be performed.

Example Embodiment 10. The method of any one of Example Embodiments 1 to 9, wherein determining the impact of switching from the first active BWP to the second BWP in the first cell comprises: determining a level of impact on the at least one PMO expected by switching from the first active BWP to the second BWP in the first cell.

Example Embodiment 11. The method of any one of Example Embodiments 1 to 10, wherein determining the impact of switching from the first active BWP to the second BWP in the first cell comprises: determining that that the impact on the at least one PMO of switching is expected to be critical and/or severe.

Example Embodiment 12. The method of any one of Example Embodiments 1 to 11, wherein taking the at least one action based on based on the determined impact comprises: in response to determining that the impact is expected to be critical and/or severe, adapting at least one procedure.

Example Embodiment 13. The method of any one of Example Embodiments 11 to 12, wherein the impact may be determined to be critical and/or severe in response to a determination of at least one of: the at least one at least one positioning measurement comprises an emergency positioning measurement that will not be triggered in response to the switch from the first active BWP to the second active BWP; an estimated accuracy of performing the at least one positioning measurement is below a first threshold; the wireless device will not meet at least one requirement associated with the at least one positioning measurement; the switch from the first active BWP to the second active BWP occurs during at least a portion of a PMO; the switch from the first active BWP to the second active BWP will interrupt at least one reference signal (RS) resource within a PMO; the switch from the first active BWP to the second active BWP will overlap with at least a number of RS resources; the second active BWP does not fully contain the bandwidth of a RS in a PMO associated with the first active BWP; the second active BWP contains a RS in a PMO with a bandwidth not larger than a second threshold; a bandwidth containing a RS for the first active BWP is different than a bandwidth containing a RS for the second active BWP; a bandwidth associated with the second active BWP is less than a bandwidth associated with the first active BWP by more than a third threshold (BW2<(BW1−T₃); a bandwidth associated with the second active BWP differs from a bandwidth associated with the first active BWP by more than a fourth threshold (|BW2−BW1|>=T₄); a bandwidth associated with the second active BWP is less than a fifth threshold (BW2<T₅); the switch from the first active BWP to the second active BWP will overlap with at least a number of RS resources (R1) or X % of resources in at least one PMO; the switch from the first active BWP to the second active BWP will overlap with at least a number of RS resources (R2) or Y % of resources in at least one PMO and the periodicity of the at least one PMO is longer than a sixth threshold; and the switch from the first active BWP to the second active BWP will occur during a time period that overlaps with a muted PMO.

Example Embodiment 14. The method of any one of Example Embodiments 11 to 13, wherein taking the at least one action based on based on the determined impact of switching from the first active BWP to the second BWP in the first cell comprises: stopping and/or discarding the active BWP switching from the first active BWP to the second active BWP; stopping the active BWP switching from the first active BWP to the second active BWP during a PMO and resuming the active BWP switching from the first active BWP to the second active BWP after the PMO; suspending the at least one positioning measurement while performing the active BWP switching from the first active BWP to the second active BWP; transmitting a request to a network node for a measurement gap configuration for performing the at least one positioning measurement; adapting at least one measurement requirement associated with the at least one positioning measurement; relaxing at least one measurement requirement associated with the at least one positioning measurement; extending a measurement time associated with the at least one positioning measurement; relaxing an accuracy requirement associated with the at least one positioning measurement; transmitting information associated with the determined impact of performing the active BWP switching to a network node; and transmitting information associated with the at least one action taken by the wireless device in response to determining the impact of performing the active BWP switching from the first active BWP to the second active BWP part.

Example Embodiment 15. The method of any one of Example Embodiments 1 to 10, wherein determining the impact of switching from the first active BWP to the second BWP in the first cell comprises: determining that that the impact on the at least one PMO of switching is expected to be non-critical and/or non-severe.

Example Embodiment 16. The method of Example Embodiments 15, wherein the impact may be determined to be non-critical and/or non-severe in response to a determination that the wireless device is configured with at least one measurement gap and a PMO cannot be received due to gap sharing.

Example Embodiment 17. The method of any one of Example Embodiments 15 to 16, wherein taking the at least one action based on based on the determined impact of switching from the first active BWP to the second BWP in the first cell comprises determining not to adapt a procedure associated with the at least one positioning measurement to be performed by the wireless device.

Example Embodiment 18. The method of any one of Example Embodiments 15 to 16, wherein taking the at least one action based on based on the determined impact of switching from the first active BWP to the second BWP in the first cell comprises switching from the first active BWP to the second BWP without impacting the at least one positioning measurement.

Example Embodiment 19. The method of any one of Example Embodiments 1 to 18, wherein the wireless device is served by at least one serving cell and the first cell is a cell within the at least one serving cell.

Example Embodiment 20. The method of any one of Example Embodiments 1 to 18, wherein the wireless device is served by at least one serving cell and the first cell is not a cell within the at least one serving cell.

Example Embodiment 21. The method of any one of Embodiments 1 to 20, wherein the wireless device is configured to perform positioning measurements for a set of cells and the first cell is within the set of cells.

Example Embodiment 22. The method of Example Embodiment 21, wherein the set of cells comprises a set of serving cells.

Example Embodiment 23. The method of Example Embodiment 21, wherein the set of cells comprises a set of neighboring cells.

Example Embodiment 24. The method of Example Embodiments 1 to 23, wherein the wireless device is configured to perform at least one positioning measurement based on at least one reference signal for the first cell.

Example Embodiment 25. The method of Example Embodiment 24, wherein the at least one reference signal comprises at least one of: a positioning reference signal (PRS); a sounding reference signal (SRS); a synchronization signal block (SSB); and a channel state information-reference signal (CSI-RS).

Example Embodiment 26. The method of Example Embodiments 24 to 25, wherein the at least one positioning measurement comprises least one of: a Reference Signal Time Difference (RSTD); a Positioning Reference Signal-Reference Signal Received Power (PRS-RSRP); a Positioning Reference Signal-Reference Signal Received Quality (PRS-RSRQ); a User Equipment Receive-Transmit (UE Rx-Tx) time difference; a Synchronization Signal-Reference Signal Received Power (SS-RSRP); a Synchronization Signal-Reference Signal Received Quality (SS-RSRQ); a Channel State Information-Reference Signal Received Power (CSI-RSRP); a Channel State Information-Reference Signal Received Quality (CSI-RSRQ); a Reference Signal Strength Indication (RSSI).

Example Embodiment 27. The method of Example Embodiments 1 to 26, wherein the first cell comprises: a special cell (SpCell), a Secondary Cell (SCell), a Primary Cell (PCell), or a Primary Secondary Cell (PSCell).

Example Embodiment 28. A wireless device comprising processing circuitry configured to perform any of the methods of Example Embodiments 1 to 27.

Example Embodiment 29. A computer program comprising instructions which when executed on a computer perform any of the methods of Example Embodiments 1 to 27.

Example Embodiment 30. A computer program product comprising computer program, the computer program comprising instructions which when executed on a computer perform any of the methods of Example Embodiments 1 to 27.

Example Embodiment 31. A non-transitory computer readable medium storing instructions which when executed by a computer perform any of the methods of Example Embodiments 1 to 27.

Example Embodiment 32. A method performed by a network node, the method comprising: receiving information associated with an impact of performing active bandwidth part (BWP) switching by a wireless device on at last one positioning measurement to be performed by the wireless device, the active BWP switching from a first active BWP to a second BWP in a first cell.

Example Embodiment 33. The method of Example Embodiment 32, further comprising taking at least one action based on the information.

Example Embodiment 34. The method of Example Embodiment 33, wherein the at least one action comprises at least one of: adapting a positioning measurement configuration; modifying a parameter associated with a positioning measurement configuration and transmitting the parameter and/or the modified positioning measurement configuration to the wireless device; changing a reference signal (RS) bandwidth and/or a RS periodicity and/or a number of time resources containing RS within a Positioning Measurement Occasion (PMO); increase a bandwidth of RS above certain threshold; reduce a periodicity of RS below certain threshold; increase a number of time resources containing RS within PMO above certain threshold; delaying a RS; triggering a RS early; triggering an additional RS instance to avoid or reduce the impact; changing a type of the at least one positioning measurement to avoid or reduce the impact; adapting the active BWP switching to a time period that does not contain any RS to be used by the wireless device for performing the at least one positioning measurement; adapting the active BWP switching assumed to be used by the wireless device; configuring the wireless device to repeat the at least one positioning measurement; configuring the wireless device to use aperiodic positioning resources to compensate for the impact; and adapting an adaptive BWP switching configuration to a PMO configuration to ensure that the active BWP switching does not occur later than a threshold amount before the PMO.

Example Embodiment 35. The method of Example Embodiment 34, further comprising transmitting information associated with the at least one action taken by the network node to the wireless device.

Example Embodiment 36. The method of any one of Example Embodiments 32 to 35, wherein the information is received from the wireless device.

Example Embodiment 37. The method of Example Embodiment 36, wherein the network node is a positioning node or a base station serving the wireless device.

Example Embodiment 38. The method of any one of Example Embodiments 32 to 35, wherein the information is received from another network node.

Example Embodiment 39. The method of Example Embodiment 38, wherein the network node comprises a positioning node and the other network node comprises a base station serving the wireless device.

Example Embodiment 40. The method of Example Embodiment 38, wherein the network node comprises a base station serving the wireless device and the other network node comprises a positioning node.

Example Embodiment 41. The method of any one of Example Embodiments 32 to 40, further comprising configuring the wireless device to: determine the impact of performing the active BWP switching from a first active BWP to a second BWP in the first cell on the at least one positioning measurement to be performed by the wireless device; and take at least one user equipment (UE) action based on based on the determined impact of switching from the first active BWP to the second BWP in the first cell.

Example Embodiment 42. The method of Example Embodiment 41, further comprising configuring the wireless device to, determine that active BWP switching from the first active BWP to the second BWP has been or will be triggered in the first cell and determine the impact in response to determining that the active BWP switching has been or will be triggered.

Example Embodiment 43. The method of any one of Example Embodiments 41 to 42, wherein configuring the wireless device to determine the impact of switching from the first active BWP to the second BWP in the first cell comprises configuring the wireless device to: determine that the switching from the first active BWP to the second BWP will affect at least one PMO during which the at least one positioning measurement is to be performed.

Example Embodiment 44. The method of any one of Example Embodiments 41 to 43, wherein configuring the wireless device to determine the impact of switching from the first active BWP to the second BWP in the first cell comprises configuring the wireless device to determine a level of impact on the at least one PMO expected by switching from the first active BWP to the second BWP in the first cell.

Example Embodiment 45. The method of any one of Example Embodiments 41 to 44, wherein configuring the wireless device to determine the impact of switching from the first active BWP to the second BWP in the first cell comprises configuring the wireless device to: determine that that the impact on the at least one PMO of switching is expected to be critical and/or severe.

Example Embodiment 46. The method of any one of Example Embodiments 41 to 45, wherein configuring the wireless device to take the at least one action based on based on the determined impact comprises configuring the wireless device to: in response to determining that the impact is expected to be critical and/or severe, adapt at least one procedure.

Example Embodiment 47. The method of any one of Example Embodiments 45 to 46, wherein configuring the wireless device to determine that the impact is critical and/or severe comprises configuring the wireless device to determine at least one of: the at least one at least one positioning measurement comprises an emergency positioning measurement that will not be triggered in response to the switch from the first active BWP to the second active BWP; an estimated accuracy of performing the at least one positioning measurement is below a first threshold; the wireless device will not meet at least one requirement associated with the at least one positioning measurement; the switch from the first active BWP to the second active BWP occurs during at least a portion of a PMO; the switch from the first active BWP to the second active BWP will interrupt at least one reference signal (RS) resource within a PMO; the switch from the first active BWP to the second active BWP will overlap with at least a number of RS resources; the second active BWP does not fully contain the bandwidth of a RS in a PMO associated with the first active BWP; the second active BWP contains a RS in a PMO with a bandwidth not larger than a second threshold; a bandwidth containing a RS for the first active BWP is different than a bandwidth containing a RS for the second active BWP; a bandwidth associated with the second active BWP is less than a bandwidth associated with the first active BWP by more than a third threshold (BW2<(BW1−T₃); a bandwidth associated with the second active BWP differs from a bandwidth associated with the first active BWP by more than a fourth threshold (|BW2−BW1|>=T₄); a bandwidth associated with the second active BWP is less than a fifth threshold (BW2<T₅); the switch from the first active BWP to the second active BWP will overlap with at least a number of RS resources (R1) or X % of resources in at least one PMO; the switch from the first active BWP to the second active BWP will overlap with at least a number of RS resources (R2) or Y % of resources in at least one PMO and the periodicity of the at least one PMO is longer than a sixth threshold; and the switch from the first active BWP to the second active BWP will occur during a time period that overlaps with a muted PMO.

Example Embodiment 48. The method of any one of Example Embodiments 41 to 47, wherein configuring the wireless device to take the at least one action based on based on the determined impact of switching from the first active BWP to the second BWP in the first cell comprises configuring the wireless device to: stop and/or discard the active BWP switching from the first active BWP to the second active BWP; stop the active BWP switching from the first active BWP to the second active BWP during a PMO and resume the active BWP switching from the first active BWP to the second active BWP after the PMO; suspend the at least one positioning measurement while performing the active BWP switching from the first active BWP to the second active BWP; transmit a request to a network node for a measurement gap configuration for performing the at least one positioning measurement; adapt at least one measurement requirement associated with the at least one positioning measurement; relax at least one measurement requirement associated with the at least one positioning measurement; extend a measurement time associated with the at least one positioning measurement; relax an accuracy requirement associated with the at least one positioning measurement; transmitting information associated with the determined impact of performing the active BWP switching to a network node; and transmit information associated with the at least one action taken by the wireless device in response to determining the impact of performing the active BWP switching from the first active BWP to the second active BWP part.

Example Embodiment 49. The method of any one of Example Embodiments 41 to 48, further comprising configuring the wireless device to determine the impact of performing the active BWP switching from a first active BWP to a second BWP in the first cell in response to an expiration of a timer.

Example Embodiment 50. The method of any one of Example Embodiments 41 to 48, further comprising configuring the wireless device to monitor the first cell and determine the impact of performing the active BWP switching based on the monitoring of the first cell.

Example Embodiment 51. The method of Example Embodiment 50, wherein configuring the wireless device to monitor the first cell comprises configuring the wireless device to monitor the first cell during at least one positioning measurement occasion (PMO).

Example Embodiment 52. The method of Example Embodiment 51, wherein the PMO comprises a measurement gap for performing the at least one positioning measurement.

Example Embodiment 53. The method of any one of Example Embodiments 41 to 52, wherein configuring the wireless device to determine the impact of switching from the first active BWP to the second BWP in the first cell comprises configuring the wireless device to: determine that that the impact on the at least one PMO of switching is expected to be non-critical and/or non-severe.

Example Embodiment 54. The method of Example Embodiments 53, wherein the impact may be determined to be non-critical and/or non-severe in response to a determination that the wireless device is configured with at least one measurement gap and a PMO cannot be received due to gap sharing.

Example Embodiment 55. The method of any one of Example Embodiments 53 to 54, wherein configuring the wireless device to take the at least one action based on based on the determined impact of switching from the first active BWP to the second BWP in the first cell comprises configuring the wireless device to determine not to adapt a procedure associated with the at least one positioning measurement to be performed by the wireless device.

Example Embodiment 56. The method of any one of Example Embodiments 53 to 54, wherein configuring the wireless device to take the at least one action based on based on the determined impact of switching from the first active BWP to the second BWP in the first cell comprises configuring the wireless device to switch from the first active BWP to the second BWP without impacting the at least one positioning measurement.

Example Embodiment 57. The method of any one of Example Embodiments 32 to 56, further comprising transmitting at least one message to the wireless device to trigger the active BWP switching.

Example Embodiment 58. The method of Example Embodiment 57, wherein the at least one message comprises a downlink control information (DCI) message.

Example Embodiment 59. The method of any one of Example Embodiments 32 to 58, wherein the wireless device is served by at least one serving cell and the first cell is a cell within the at least one serving cell.

Example Embodiment 60. The method of any one of Example Embodiments 32 to 58, wherein the wireless device is served by at least one serving cell and the first cell is not a cell within the at least one serving cell.

Example Embodiment 61. The method of any one of Example Embodiments 32 to 60, wherein the wireless device is configured to perform positioning measurements for a set of cells and the first cell is within the set of cells.

Example Embodiment 62. The method of Example Embodiment 61, wherein the set of cells comprises a set of serving cells.

Example Embodiment 63. The method of Example Embodiment 61, wherein the set of cells comprises a set of neighboring cells.

Example Embodiment 64. The method of any one of Example Embodiments 32 to 63, further comprising configuring the wireless device to perform the at least one positioning measurement based on at least one reference signal for the first cell.

Example Embodiment 65. The method of Example Embodiment 64, wherein the at least one reference signal comprises at least one of: a positioning reference signal (PRS); a sounding reference signal (SRS); a synchronization signal block (SSB); and a channel state information-reference signal (CSI-RS).

Example Embodiment 66. The method of any one of Example Embodiments 32 to 65, wherein the at least one positioning measurement comprises least one of: a Reference Signal Time Difference (RSTD); a Positioning Reference Signal-Reference Signal Received Power (PRS-RSRP); a Positioning Reference Signal-Reference Signal Received Quality (PRS-RSRQ); a User Equipment Receive-Transmit (UE Rx-Tx) time difference; a Synchronization Signal-Reference Signal Received Power (SS-RSRP); a Synchronization Signal-Reference Signal Received Quality (SS-RSRQ); a Channel State Information-Reference Signal Received Power (CSI-RSRP); a Channel State Information-Reference Signal Received Quality (CSI-RSRQ); and a Reference Signal Strength Indication (RSSI).

Example Embodiment 67. The method of Example Embodiments 32 to 66, wherein the first cell comprises: a special cell (SpCell), a Secondary Cell (SCell), a Primary Cell (PCell), or a Primary Secondary Cell (PSCell).

Example Embodiment 68. A network node comprising processing circuitry configured to perform any of the methods of Example Embodiments 32 to 67.

Example Embodiment 69. A computer program comprising instructions which when executed on a computer perform any of the methods of Example Embodiments 32 to 67.

Example Embodiment 70. A computer program product comprising computer program, the computer program comprising instructions which when executed on a computer perform any of the methods of Example Embodiments 32 to 67.

Example Embodiment 71. A non-transitory computer readable medium storing instructions which when executed by a computer perform any of the methods of Example Embodiments 32 to 67.

Example Embodiment 72. A wireless device comprising: processing circuitry configured to perform any of the steps of any of Example Embodiments 1 to 31; and power supply circuitry configured to supply power to the wireless device.

Example Embodiment 73. A network node comprising: processing circuitry configured to perform any of the steps of any of Example Embodiments 32 to 71; power supply circuitry configured to supply power to the wireless device.

Example Embodiment 74. A wireless device, the wireless device comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of Example Embodiments 1 to 31; an input interface connected to the processing circuitry and configured to allow input of information into the wireless device to be processed by the processing circuitry; an output interface connected to the processing circuitry and configured to output information from the wireless device that has been processed by the processing circuitry; and a battery connected to the processing circuitry and configured to supply power to the wireless device.

Example Embodiment 75. A communication system including a host computer comprising: processing circuitry configured to provide user data; and a communication interface configured to forward the user data to a cellular network for transmission to a wireless device, wherein the cellular network comprises a network node having a radio interface and processing circuitry, the network node's processing circuitry configured to perform any of the steps of any of Example Embodiments 32 to 71.

Example Embodiment 76. The communication system of the pervious embodiment further including the network node.

Example Embodiment 77. The communication system of the previous 2 embodiments, further including the wireless device, wherein the wireless device is configured to communicate with the network node.

Example Embodiment 78. The communication system of the previous 3 embodiments, wherein: the processing circuitry of the host computer is configured to execute a host application, thereby providing the user data; and the wireless device comprises processing circuitry configured to execute a client application associated with the host application.

Example Embodiment 79. A method implemented in a communication system including a host computer, a network node and a wireless device, the method comprising: at the host computer, providing user data; and at the host computer, initiating a transmission carrying the user data to the wireless device via a cellular network comprising the network node, wherein the network node performs any of the steps of any of Example Embodiments 32 to 71.

Example Embodiment 80. The method of the previous embodiment, further comprising, at the network node, transmitting the user data.

Example Embodiment 81. The method of the previous 2 embodiments, wherein the user data is provided at the host computer by executing a host application, the method further comprising, at the wireless device, executing a client application associated with the host application.

Example Embodiment 82. A wireless device configured to communicate with a network node, the wireless device comprising a radio interface and processing circuitry configured to performs the of the previous 3 embodiments.

Example Embodiment 83. A communication system including a host computer comprising: processing circuitry configured to provide user data; and a communication interface configured to forward user data to a cellular network for transmission to a wireless device, wherein the wireless device comprises a radio interface and processing circuitry, the wireless device's components configured to perform any of the steps of any of Example Embodiments 1 to 31.

Example Embodiment 84. The communication system of the previous embodiment, wherein the cellular network further includes a network node configured to communicate with the wireless device.

Example Embodiment 85. The communication system of the previous 2 embodiments, wherein: the processing circuitry of the host computer is configured to execute a host application, thereby providing the user data; and the wireless device's processing circuitry is configured to execute a client application associated with the host application.

Example Embodiment 86. A method implemented in a communication system including a host computer, a network node and a wireless device, the method comprising: at the host computer, providing user data; and at the host computer, initiating a transmission carrying the user data to the wireless device via a cellular network comprising the network node, wherein the wireless device performs any of the steps of any of Example Embodiments 1 to 31.

Example Embodiment 87. The method of the previous embodiment, further comprising at the wireless device, receiving the user data from the network node.

Example Embodiment 88. A communication system including a host computer comprising: communication interface configured to receive user data originating from a transmission from a wireless device to a network node, wherein the wireless device comprises a radio interface and processing circuitry, the wireless device's processing circuitry configured to perform any of the steps of any of Example Embodiments 1 to 31.

Example Embodiment 89. The communication system of the previous embodiment, further including the wireless device.

Example Embodiment 90. The communication system of the previous 2 embodiments, further including the network node, wherein the network node comprises a radio interface configured to communicate with the wireless device and a communication interface configured to forward to the host computer the user data carried by a transmission from the wireless device to the network node.

Example Embodiment 91. The communication system of the previous 3 embodiments, wherein: the processing circuitry of the host computer is configured to execute a host application; and the wireless device's processing circuitry is configured to execute a client application associated with the host application, thereby providing the user data.

Example Embodiment 92. The communication system of the previous 4 embodiments, wherein: the processing circuitry of the host computer is configured to execute a host application, thereby providing request data; and the wireless device's processing circuitry is configured to execute a client application associated with the host application, thereby providing the user data in response to the request data.

Example Embodiment 93. A method implemented in a communication system including a host computer, a network node and a wireless device, the method comprising: at the host computer, receiving user data transmitted to the network node from the wireless device, wherein the wireless device performs any of the steps of any of Example Embodiments 1 to 31.

Example Embodiment 94. The method of the previous embodiment, further comprising, at the wireless device, providing the user data to the network node.

Example Embodiment 95. The method of the previous 2 embodiments, further comprising: at the wireless device, executing a client application, thereby providing the user data to be transmitted; and at the host computer, executing a host application associated with the client application.

Example Embodiment 96. The method of the previous 3 embodiments, further comprising: at the wireless device, executing a client application; and at the wireless device, receiving input data to the client application, the input data being provided at the host computer by executing a host application associated with the client application, wherein the user data to be transmitted is provided by the client application in response to the input data.

Example Embodiment 97. A communication system including a host computer comprising a communication interface configured to receive user data originating from a transmission from a wireless device to a network node, wherein the network node comprises a radio interface and processing circuitry, the network node's processing circuitry configured to perform any of the steps of any of Example Embodiments 32 to 71.

Example Embodiment 98. The communication system of the previous embodiment further including the network node.

Example Embodiment 99. The communication system of the previous 2 embodiments, further including the wireless device, wherein the wireless device is configured to communicate with the network node.

Example Embodiment 100. The communication system of the previous 3 embodiments, wherein: the processing circuitry of the host computer is configured to execute a host application; the wireless device is configured to execute a client application associated with the host application, thereby providing the user data to be received by the host computer.

Example Embodiment 101. A method implemented in a communication system including a host computer, a network node and a wireless device, the method comprising: at the host computer, receiving, from the base station, user data originating from a transmission which the network node has received from the wireless device, wherein the wireless device performs any of the steps of any of Example Embodiments 1 to 31.

Example Embodiment 102. The method of the previous embodiment, further comprising at the network node receiving the user data from the wireless device.

Example Embodiment 103. The method of the previous 2 embodiments, further comprising at the network node, initiating a transmission of the received user data to the host computer.

Example Embodiment 104. The method of any of the previous embodiments, wherein the network node comprises a base station.

Example Embodiment 105. The method of any of the previous embodiments, wherein the wireless device comprises a user equipment (UE).

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

### Additional Information: Impact of Active BWP Change on Positioning Measurements

In RAN4 #94-e meeting, the WF on impact of positioning measurements on RRM requirements was approved. See, R4-2002276, WF on NR Positioning measurement impact on RRM requirements, Qualcomm.

The following issue related to the active BWP switching and positioning measurements has been identified for further studies in the WF:
RAN4 to further study and discuss if:
PRS-RSTD and PRS-RSRP measurement requirements apply when UE's active DL BWP is changed during the measurement period.
UE Rx-Tx time difference measurement requirements apply when UE's active DL and UL BWP is changed during the measurement period
   See, id. Herein, the impact of active BWP switching on positioning measurements is analyzed.

The UE positioning measurement can be performed without measurement gaps or with measurement gaps. The consequence of the BWP switching on the UE positioning measurements depend on whether the gaps are used or not. Therefore, we consider both cases in the following sections. The analysis in general apply to all the UE positioning measurements (RSTD, PRS-RSRP and UE Rx-Tx time difference) unless explicitly stated otherwise.

UE Positioning Measurement without Gaps

The definition of intra-frequency RSTD (and PRS-RSRP) is still under discussion. But regardless of the agreed definition, at least intra-frequency RSTD and intra-frequency PRS-RSRP measurement can be done without measurement gaps provided that the PRS BW of the measured PRS is within the UE's DL active BWP. Additional conditions for measurement without gaps may also apply e.g. SCS of PRS and that of the DL active BWP are the same.

UE Rx-Tx time difference measurement is done on at least the serving cell. So at least the UE Rx-Tx time difference measurement in the serving cell can be done provided that the PRS BW and SRS BW are within the UE's DL active BWP and UL active BWP, respectively. Also, in this case, additional conditions for measurement without gaps may also apply e.g. SCSs of PRS and SRS and those of DL and UL active BWPs, respectively, are the same.

It has also been proposed that, “PRS-RSTD and PRS-RSRP measurement requirements apply when UE's active DL BWP is not changed during the measurement period.” See, R4-2000737, On impact of NR positioning on existing RRM requirements, Qualcomm.

This implicitly means that the gNB is not allowed to perform any active BWP switching while the UE is performing PRS-RSTD and PRS-RSRP measurement. This is very strict condition imposing big limitation on the network especially on scheduling and interference management.

In NR, the BW can be very large BW. The positioning measurement period depends on PRS/SRS resources configured for the measurement and especially on their periodicities, which can be very long e.g. up to 20480 slots for PRS and 2560 slots for SRS. Therefore, both from UE power consumption and interference point of view it is not advisable for gNB to operate the active BWP over unnecessary larger BW i.e. more than the BW needed for scheduling the UE. Accordingly, the UE should be allowed to perform the positioning measurements within the UE's active BWP without impacting or influencing any active BWP switching operation in gNB.

The active BW switching during the positioning measurement period will not impact the PRS (or SRS) for example:
if is done between the successive PRS resource occasions and the PRS resource periodicity is long enough to avoid any overlap between PRS and the active BWP switching period, and
the active BWP switching does not decrease the PRS BW below the PRS BW in the assistance data.
   But if the active BW switch interrupts the PRS or reduces the PRS BW below the PRS BW in the assistance data, the UE should be allowed to request the measurement gaps and perform the measurements in gaps. To minimize UE complexity, the UE should be allowed to restart the measurement and meet the corresponding requirements with measurement gaps.
Observation#1: Restricting gNB from perform any active BWP switching during the positioning measurement period imposes big limitation on the network scheduling and interference management.
Proposal #1: When the RSTD/PRS-RSRP measurement is done within the UE's active BWP then the UE shall meet RSTD/PRS-RSRP measurement requirements provided that active BW switching during the RSTD/PRS-RSRP measurement period does not interrupt PRS used for the measurement and does not decrease the PRS BW below the PRS BW in the assistance data.
Proposal #2: If conditions in proposal # 1 are not met then the UE requests the gNB to configure the measurement gaps. In this case the UE restarts the RSTD/PRS-RSRP measurement and meet the requirements for RSTD/PRS-RSRP measurement with gaps.
Proposal #3: The principles in proposals #1 and #2 also apply for UE Rx-Tx time difference measurement.

UE Positioning Measurement with Gaps

The requirements will be defined for positioning measurement with gaps. Both intra-frequency and inter-frequency positioning measurements may need to be defined with gaps. At least there is consensus that inter-frequency positioning measurements will be defined with gaps.

Currently, the UE behaviour for handling the BWP switching if it occurs just before or during the gaps (e.g. timer-based) is unclear in RAN4 specifications. For RRM measurements, which are fully managed by the gNB, the risk of collision between the BWP switching and gaps is low.

But positioning measurements are configured by the LMF and based on this the UE may request the gNB to configure the gaps for doing positioning measurements. RAN4 has also identified potential need for new gaps with MGL>6 ms for positioning measurements. A large measurement gap increases the potential risk of active BWP switching triggering before the gap. Especially the timer-based BWP switching if configured prior to receiving UE request for gaps for positioning measurements. Unlike SSB, the PRS resource and SRS resource (for positioning) will typically be transmitted very sparsely e.g. once every 2560 slots etc. Therefore, it is important to define UE behaviour to avoid a situation where the BWP switching does not impact any measurement gap. As such, the gaps should not be impacted. Therefore, if any active BWP switching will impact the gap then the UE should prioritize the gap and complete the active BWP switching immediately after the gap.
Observation#2: The UE behaviour for handling the active BWP switching occurring just before the gaps or timer-based BWP switching during the gaps.
Observation#3: The use of measurement gap with MGL much larger than 6 ms and sparse occurs of PRS and SRS increases the risk of BWP switching triggering before the gap or timer-based BWP switching triggering during the gaps.
Proposal #4: If active BWP switching is expected to impact any measurement gap used for the positioning measurements then the UE shall prioritize the gap and complete the active BWP switching immediately after the gap.

In Summary, the impact of active BWP switching on positioning measurements in NR. Following are the main observation and proposals:

Observations and Proposals for Positioning Measurements Without Gaps:
Observation#1: Restricting gNB from perform any active BWP switching during the positioning measurement period imposes big limitation on the network scheduling and interference management.
Proposal #1: When the RSTD/PRS-RSRP measurement is done within the UE's active BWP then the UE shall meet RSTD/PRS-RSRP measurement requirements provided that active BW switching during the RSTD/PRS-RSRP measurement period does not interrupt PRS used for the measurement and does not decrease the PRS BW below the PRS BW in the assistance data.
Proposal #2: If conditions in proposal #1 are not met then the UE requests the gNB to configure the measurement gaps. In this case the UE restarts the RSTD/PRS-RSRP measurement and meet the requirements for RSTD/PRS-RSRP measurement with gaps.
Proposal #3: The principles in proposals #1 and #2 also apply for UE Rx-Tx time difference measurement.

Observations and Proposals for Positioning Measurements with Gaps:
Observation #2: The UE behaviour for handling the active BWP switching occurring just before the gaps or timer-based BWP switching during the gaps.
Observation#3: The use of measurement gap with MGL much larger than 6 ms and sparse occurs of PRS and SRS increases the risk of BWP switching triggering before the gap or timer-based BWP switching triggering during the gaps.
Proposal #4: If active BWP switching is expected to impact any measurement gap used for the positioning measurements then the UE shall prioritize the gap and complete the active BWP switching immediately after the gap.

1. A method by a wireless device, the method comprising:
determining that switching from a first active bandwidth part, BWP, to a second BWP in a first cell will affect at least one positioning measurement occasion, PMO, during which at least one positioning measurement is to be performed; and
suspending the at least one positioning measurement while performing the active BWP switching from the first active BWP to the second active BWP in the first cell.

2. The method of claim 1, wherein determining that switching from the first active BWP to the second BWP will affect at least one PMO during which at least one positioning measurement is to be performed comprises:
determining that the wireless device will not meet at least one requirement associated with the at least one positioning measurement.

3. The method of claim 2, wherein the at least one requirement comprises one or more positioning measurement requirements for performing the at least one positioning measurement by the wireless device.

4. The method of claim 2, further comprising at least one of:
adapting the at least one requirement associated with the at least one positioning measurement;
relaxing the at least one requirement associated with the at least one positioning measurement;
extending a measurement time associated with the at least one positioning measurement;
relaxing an accuracy requirement associated with the at least one positioning measurement.

5. The method of claim 2, wherein determining that switching from the first active BWP to the second BWP will affect at least one PMO during which at least one positioning measurement is to be performed comprises:
determining that the switch from the first active BWP to the second active BWP overlaps in time or frequency with one or more resources of the at least one PMO.

6. The method of claim 1, further comprising:
prior to determining the effect of switching from the first active BWP to the second active BWP, determining that the active BWP switching from the first active BWP to the second BWP has been or will be triggered in the first cell based on:
at least one message received from a network nodc (160); or
an expiration of a timer.

7. The method of claim 1, further comprising monitoring the first cell during the at least one PMO, and wherein the determining step is based on the monitoring of the first cell.

8.-10. (canceled)

11. The method of claim 1, further comprising:
transmitting a request to a network node for a measurement gap configuration for performing the at least one positioning measurement.

12. The method of claim 11, further comprising:
upon configuration of the measurement gaps, restarting the at least one positioning measurement by discarding previous measurement samples and performing the at least one positioning measurement in the measurement gaps.

13. The method of claim 1, further comprising:
transmitting information indicating that the wireless device has suspended the at least one positioning measurement while performing the active BWP switching from the first active BWP to the second active BWP.

14. The method of claim 1, wherein the wireless device is served by at least one serving cell and the first cell is a cell within the at least one serving cell.

15. The method of claim 1, wherein the wireless device is served by at least one serving cell and the first cell is not a cell within the at least one serving cell.

16. The method of claim 1, wherein the wireless device is configured to perform positioning measurements for a set of cells and the first cell is within the set of cells, and wherein the set of cells comprises a set of serving cells or a set of neighboring cells.

17. The method of claim 1, wherein the at least one positioning measurement comprises at least one of:
a Reference Signal Time Difference, RSTD;
a Positioning Reference Signal-Reference Signal Received Power, PRS-RSRP;
a Positioning Reference Signal-Reference Signal Received Quality, PRS-RSRQ;
a User Equipment Receive-Transmit, UE Rx-Tx, time difference;
a Synchronization Signal-Reference Signal Received Power, SS-RSRP;
a Synchronization Signal-Reference Signal Received Quality, SS-RSRQ;
a Channel State Information-Reference Signal Received Power, CSI-RSRP;
a Channel State Information-Reference Signal Received Quality, CSI-RSRQ; and
a Reference Signal Strength Indication, RSSI.

18. A wireless device comprising processing circuitry configured to:
determine that switching from a first active bandwidth part, BWP, to a second BWP in a first cell will affect at least one positioning measurement occasion, PMO during which at least one positioning measurement is to be performed; and
suspend the at least one positioning measurement while performing the active BWP switching from the first active BWP to the second active BWP.

19. (canceled)

20. A method by a network node, the method comprising:
receiving a request for a measurement gap configuration for performing at least one positioning measurement by a wireless device while or in response to performing active bandwidth part, BWP, switching from a first active BWP to a second BWP in a first cell;
modifying a positioning measurement configuration to include a measurement gap configuration; and
transmitting the modified positioning measurement configuration including the measurement gap configuration to the wireless device.

21. The method of claim 20, further comprising taking at least one action, the at least one action comprising at least one of:
changing a reference signal, RS, bandwidth and/or a RS periodicity and/or a number of time resources containing RS within a Positioning Measurement Occasion, PMO;
increase a bandwidth of RS above certain threshold;
reduce a periodicity of RS below certain threshold;
increase a number of time resources containing RS within PMO above certain threshold;
delaying a RS;
triggering a RS early;
triggering an additional RS instance to avoid or reduce the impact;
changing a type of the at least one positioning measurement to avoid or reduce the impact;
adapting the active BWP switching to a time period that does not contain any RS to be used by the wireless device for performing the at least one positioning measurement;
adapting the active BWP switching assumed to be used by the wireless device;
configuring the wireless device to repeat the at least one positioning measurement;
configuring the wireless device to use aperiodic positioning resources to compensate for the impact; and
adapting an adaptive BWP switching configuration to a PMO configuration to ensure that the active BWP switching does not occur later than a threshold amount before the PMO.

22. The method of claim 21, further comprising transmitting information associated with the at least one action taken by the network node to the wireless device.

23. The method of claim 20, wherein the request is received from the wireless device.

24. (canceled)

25. The method of claim 20, wherein the request is received from another network node.

26.-27. (canceled)

28. The method of claim 20, further comprising configuring the wireless device to:
determine whether switching from the first active BWP to the second BWP will affect at least one positioning measurement occasion (PMO) during which the at least one positioning measurement is to be performed;
in response to determining that switching from the first active BWP to the second BWP will affect the at least one PMO, suspend the at least one positioning measurement while performing the active BWP switching from the first active BWP to the second active BWP; and
transmit the request for the measurement gap configuration for performing at least one positioning measurement by a wireless device.

29. The method of claim 28, wherein configuring the wireless device to determine whether switching from the first active BWP to the second BWP will affect the at least one PMO during which the at least one positioning measurement is to be performed comprises:
configuring the wireless device to determine a level of impact on the at least one PMO expected by switching from the first active BWP to the second BWP in the first cell.

30. (canceled)

31. The method of claim 20, further comprising transmitting at least one message to the wireless device to trigger the active BWP switching.

32. The method of claim 31, wherein the at least one message comprises a downlink control information, DCI, message.

33. The method of claim 20, wherein the wireless device is served by at least one serving cell and the first cell is a cell within the at least one serving cell.

34. The method of claim 20, wherein the wireless device is served by at least one serving cell and the first cell is not a cell within the at least one serving cell.

35. The method of claim 20, wherein the wireless device is configured to perform positioning measurements for a set of cells and the first cell is within the set of cells.

36.-37. (canceled)

38. A network node comprising processing circuitry configured to:
receive a request for a measurement gap configuration for performing at least one positioning measurement by a wireless device while performing active bandwidth part, BWP, switching from a first active BWP to a second BWP in a first cell;
modify a positioning measurement configuration to include a measurement gap configuration; and
transmit the modified positioning measurement configuration including the measurement gap configuration to the wireless device.

39. (canceled)

40. (canceled)
